(19) United States
(12) Patent Application Publication
(10) Pub. No.: US 2001/0047411 A1
(43) Pub. Date: Nov. 29, 2001

(54) Server

(76) Inventors: Yoshitoshi Kurose, Kawasaki (JP); Yuji Nomura, Kawasaki (JP); Kazuyo Miyamoto, Kawasaki (JP)

Correspondence Address: HELFGOTT & KARAS, P.C., EMPIRE STATE BUILDING, 60TH FLOOR, NEW YORK, NY, 10118, US

(21) Appl. No.: 09/810,260

(22) Filed: Mar. 16, 2001

(30) Foreign Application Priority Data
Apr. 9, 2000 (JP) 2000-266991

(51) Int. Cl. G06F 15/173; G06F 15/16

(52) U.S. Cl. 709/225; 709/249

(57) ABSTRACT

A server which manages an agreement of a service offered between domains through a network, for automatically renewing services offered by or demanded by other domains depending on the change of an agreement with the other domains or network state variations. When an agreement with a server is changed, or a variation of network state occurs in other servers, an agreement associated with the other servers is correspondingly changed, and preferably the change is performed only in excess of a fixed threshold value.

### BACKGROUND OF THE INVENTION

1. Field of the Invention

The present invention relates to a server, and in particular to a server (policy server) which manages a Service Level Agreement (SLA) offered between domains mutually connected with networks and whose managers having a working policy are different.

Recently, it has been realized that a service offering domain makes or concludes a Service Level Agreement (hereinafter, abbreviated as agreement) with a service demanding side such as a user or domain to guarantee the service offer by observing a predetermined agreement for each domain to provide a service based on the agreement.

It should be noted that “agreement” will be hereinafter used to read as occasionally “contract”, “agreement for contract”, or “agreed contract”.

2. Description of the Related Art

(1) A static agreement by a domain manager has been made as follows (see FIG. 57), where the following operations respectively correspond to reference numerals therein:

1. Between domains A-B, managers thereof negotiate with each other to determine the contents of an agreement “mutual guarantee of bandwidth 10 Mbps”.

2. Each manager performs setting servers 1 and 2 respectively belonging to the domains A and B in accordance with the contents of the agreement determined.

3. The servers 1 and 2 of the domains A and B set network equipments within their own domains.

4. The network equipments offer services in accordance with the contents of the agreement.

(2) Automatic decision of the agreement between two domains with servers has been made as follows (see FIG. 58), where the servers 1 and 2 are commonly composed of a receiving unit 11, an agreement (contracting) unit 12, and a transmitting unit 13 as seen from FIG. 59:

1. The server 1 on the agreement demanding side prepares an agreement demanding (asking) message ASK at the agreement unit 12 and demands an agreement from the server 2 by the transmitting unit

13. It is to be noted that the message ASK is not required when an agreement offering (bidding) message (BID) has been received from the other side.

2. The server 2 having received the agreement demand from the receiving unit 11 writes the agreement contents having stored in the agreement unit 12 in the message BID to be transmitted to the server 1 from the transmitting unit 13.

3. The server 1 judges the agreement contents at the agreement unit 12 from the message BID received from the receiving unit 11. If they are agreed, the server 1 transmits the message ACCEPT from the transmitting unit 13.

4. Receiving the message ACCEPT from the server 1 at the receiving unit 11, the server 2 prepares at the agreement unit 12 a message CONFIRM for confirmation or a message REJECT for rejection to be transmitted from the transmitting unit 13.

5. Thus, the message ACCEPT/CONFIRM is transmitted/received from/by both sides to make an agreement between the agreement units 12 of the domains A and B.

In case that a server has an agreement with two or more servers, and the agreement contents of any of the other servers are changed, the associated or related agreements are required to be renewed or updated.

In this case, the prior art required the manager who had confirmed the change of the agreement contents to select the associated agreement and to have the server renew the agreement. In the presence of a number of agreements, upon the change of the contents, the manager was required to conduct numerous manual works for the respective changes. Also, there was a possibility of artificial failure due to such a manual setting.

The above noted agreement by manager's manual works has the following issue (1) (see FIG. 60):

1. Domains A and B respectively having a server (not shown) mutually make or conclude an agreement to the effect that a bandwidth of 10 Mbps is guaranteed or assured for the communication from the domain A.

2. The domain B has now become disabled to guarantee the bandwidth of 10 Mbps due to a fault (performance deterioration) of network equipments.

3. At this time, since the domain B is not provided with such a function that the change of network state is detected to select the associated agreement to be automatically renewed, the fault of network equipments detected by the domain B is not informed to the domain A until the manager manually renews the agreement. Therefore, while the domain A continues the communication based on the bandwidth guarantee of 10 Mbps, the domain B can not guarantee the bandwidth of the, communication, so that the communication data from the domain A may be abolished or delayed.

Further more, in case of automatic agreement between servers, the following issue (2) arises (see FIG. 61):

1. The domains A and B mutually make such an agreement that the bandwidth of 10 Mbps is guaranteed for the communication from the domain A.

2. The domains B and C mutually make such an agreement that the bandwidth of 10 Mbps is guaranteed for the communication from the domain B.

3. Depending on the state of the domain C, the contents of the agreement for guaranteeing the bandwidth of 10 Mbps has been made between the domain B and C is now changed to that of 5 Mbps.

4. Since the domain A is not provided at this time with such a function that the change of the agreement contents is detected to select the associated agreement for the renewal, the agreement contents between the domains A and B remain unchanged as the bandwidth guarantee of 10 Mbps whereby the domain A continues the communication based on the bandwidth guarantee of 10 Mbps. As a result, the bandwidth of 10 Mbps can not be guaranteed between the domains B and C, so that the communication from the domain A is not guaranteed in bandwidth, causing the communication from the domain A to be abolished or delayed between the domains B and C.

### Summary of the Invention

It is accordingly an object of the present invention, in view of such issues that an agreement made between domains can not be observed, to provide a server which manages a Service Level Agreement offered between the domains through networks wherein depending on changes of network state and of the contents of the agreement with other domains, services offered or demanded by their own domains are automatically renewed.

Hereinafter, means and functions of a server according to the presenting invention will be described taking three servers (policy servers) 1-3 mutually connected with networks as an example, as shown in FIG. 1, while being not restricted to this example. It is to be noted that the servers 1 and 2 may be prior art ones as also shown in FIG. 59 whereas only the server 3 has a feature of the present invention.

FIG. 2 shows a schematic arrangement of the server 3 according to the present invention [1]. This arrangement includes the servers 1 and 2 as shown in FIG. 59 in which an agreement renewal unit 14 is substituted for the agreement unit 12 and a domain information managing unit 15 is added. The outlined functions of those units 14 and 15 are as follows:

Agreement Renewal Unit 14:

This prepares a message for transferring agreement changing information and transmits it from the transmitting unit 13 to the outside in order to change the contents of an agreement depending on the change of the contents of the associated agreement.

Domain Information Managing Unit 15:

This manages information such as an in-domain resource and agreement contents, and renews the managing information in cooperation with the agreement renewal unit 14.

The server 3 according to the according to present invention [1] thus arranged performs an operation sequence (1) shown in FIG. 3 as follows:

1. The receiving unit 11 receives a change notification \mathring{1} regarding some agreement from the server 2 on the agreement offering side.

2. The agreement renewal unit 14 receives the contents of the change notification \mathring{1}.

3. The agreement renewal unit 14 selects an agreement with the server 3 regarding the contents of the changing notification \mathring{1} from the domain information managing unit 15 and renews the agreement.

4. The agreement renewal unit 14 also selects an agreement with another server, i.e. the server 1 to be changed regarding the contents of the change notification \mathring{1} from the domain information managing unit 15, and prepares the corresponding changing notification \mathring{1} regarding the agreement to be transmitted to the server 1 on the agreement demanding side from the transmitting unit 13 (claim 1).

Also, the server 3 according to the present invention [1] performs an operation sequence (2) shown in FIG. 4 as follows:

1. A change demand \mathring{1} regarding some agreement is received at the receiving unit 11 from the server 1 on the agreement demanding side.

2. The agreement renewal unit 14 receives the contents of the change demand \mathring{1}.

3. The agreement renewal unit 14 selects an agreement regarding the contents of a change demand \mathring{2} and renews the agreement.

4. Furthermore, the agreement renewal unit 14 selects an agreement with another server, i.e. the server 2 to be changed regarding the contents of the change demand \mathring{1} from the domain information managing unit 15, and prepares a change demand \mathring{3} corresponding thereto regarding the agreement to be transmitted to the server 2 from the transmitting unit 13 (claim 2). Also, the agreement renewal unit 14 prepares a change notification \mathring{2} for the change demand \mathring{1} and transmits it to the server 1 from the transmitting unit 13 (claim 3).

5. The server 2 changes the agreement, and then transmits a change notification \mathring{4}.

6. The agreement renewal unit 14 of the server 3 receives the contents of the change notification \mathring{4}.

7. The agreement renewal unit 14 makes the domain information managing unit 15 renew the agreement with the server 2 as to the information of the change notification \mathring{4} (claim 1).

Thus, in the present invention [1], when an agreement with a server is changed, an agreement with another server can be automatically renewed.

FIG. 5 shows a schematic arrangement of the server 3 according to the present invention. This arrangement is different from the present invention [1] shown in FIG. 2 in that a network information collecting unit 16 having the following functions is added:

Network Information Collecting Unit 16:

This collects variation information of network associated with an agreement to notify the agreement renewal unit 14 of the variation information in response to the instructions from the agreement renewal unit 14.

The server 3 according to the present invention [2] of such an arrangement performs the following operation sequence (1) shown in FIG. 6:

1. The agreement renewal unit 14 makes the network information collecting unit 16 collect information \mathring{1} regarding network variation.

2. The network information collecting unit 16 collects the information \mathring{1}, that is information of network variation regarding the agreement between servers 1 and 3,to be notified to the agreement renewal unit 14.

3. Recognizing that there is a network variation on the agreement demanding side based on the acquired information, the agreement renewal unit 14 selects the agreement with the server 1 from the domain information managing unit 15 and renews the agreement so that it may correspond to the network variation.

4. Then, the agreement renewal unit 14 prepares and transmits a change demand \mathring{2} of an agreement with the server 3 to the server 2 on the agreement offering side from the transmitting unit 13 (claim 4).

5. The server 2 changes the agreement, and then returns an agreement change notification \mathring{3} in the same manner as the above (claim 1).

Also, the server 3 according to the present invention [2] performs the following operation sequence (2) as shown in FIG. 7:

1. The agreement renewal unit 14 makes the network information collecting unit 16 collect information \mathring{1} regarding network variation.

2. The network information collecting unit 16 collects the information \mathring{1}, that is information of network variation regarding the agreement between the servers 3 and 2, to be notified to the agreement renewal unit 14.

3. Recognizing that there is a network variation regarding the agreement on the agreement offering side based on the acquired information, the agreement renewal unit 14 selects the agreement with the server 2 from the domain information managing unit 15 and renews the agreement so that it may correspond to the network variation.

4. Then, the agreement renewal unit 14 prepares and transmits a change notification \mathring{2} of the agreement with the server 3 to the server 1 on the agreement demanding side from the transmitting unit 13 (claim 5).

Thus, the present invention [2] automatically enables an appropriate agreement renewal according to the variation of network state by adding the agreement renewal unit 14, the domain information managing unit 15, and the network information collecting unit 16 to the server 3 to detect the variation of network state regarding an agreement to be transferred to an external server.

FIG. 8 shows a schematic arrangement of the server 3 according to the present invention [3]. This arrangement is different from the present invention [1] shown in FIG. 2 in that an inter-domain cooperating unit 17 having the following functions is added:

Inter-domain cooperating unit 17:

This detects an associated server or agreement contents with respect to an agreement demand or agreement offer to be notified to the agreement renewal unit 14.

The server 3 according to the present invention [3] of such an arrangement performs the following operation sequence (1) as shown in FIG. 9:

1. The receiving unit 11 receives an agreement offer \mathring{1} from the server 2 to be provided to the agreement renewal unit 14.

2. The agreement renewal unit 14 notifies the inter-domain cooperating unit 17 of the contents of the agreement offer \mathring{1}.

3. The inter-domain cooperating unit 17 acquires or obtains an agreement associated with the contents of the agreement offer \mathring{1} from the domain information managing unit 15.

4. The inter-domain cooperating unit 17 prepares a new agreement offer \mathring{2} with respect to the server 1 based on the agreement to be notified to the agreement renewal unit 14.

5. The agreement renewal unit 14 acquires, from the domain information managing unit 15, an agreement with the server 1 associated with the notification from the inter-domain cooperating unit 17, and renews the agreement corresponding to the agreement offer \mathring{2}.

6. The agreement renewal unit 14 transmits the agreement offer \mathring{2} to the server 1 from the transmitting unit 13 (claim 6).

7. The receiving unit 11 receives an agreement decision demand \mathring{3} from the server 1 followed by the agreement offer \mathring{2}.

8. The agreement renewal unit 14 notifies the inter-domain cooperating unit 17 of the contents of the agreement decision demand \mathring{3}.

9. The inter-domain cooperating unit 17 acquires the agreement associated with the contents of the agreement decision demand \mathring{3} from the domain information managing unit 15.

10. The inter-domain cooperating unit 17 prepares a new agreement decision demand \mathring{4} for the server 2 of the associated agreement to be notified to the agreement renewal unit 14.

11. The agreement renewal unit 14 acquires, from the domain information managing unit 15, the agreement with the server 2 associated with the information acquired from the inter-domain cooperating unit 17, for the renewal.

12. The agreement renewal unit 14 transmits an agreement decision demand \mathring{4} to the server 2 from the transmitting unit 13 (claim 7).

13. Since having an agreement decision response \mathring{5} as shown in FIG. 58 from the server 2 which has received that agreement decision demand \mathring{4}, the agreement renewal unit 14 executes agreement decision responses \mathring{5} and \mathring{6} shown in the same manner instead of the agreement offers \mathring{1} and \mathring{2} in the above 1˜6 (claim 8).

Also, the server 3 according to the present invention [3] performs the following operation sequence (2) as shown in FIG. 10, where it is different from FIG. 9 as shown in that agreement demands \mathring{7} and \mathring{8} are added on the assumption of the agreement offer \mathring{1} of FIG. 9 so that only these will be described:

1. The receiving unit 11 receives the agreement demand \mathring{7} from the server 1 on the agreement demand side to be provided to the agreement renewal unit 14.

2. The agreement renewal unit 14 notifies the contents of the agreement demand \mathring{7} to the inter-domain cooperating unit 17.

3. The inter-domain cooperating unit 17 acquires the information associated with the contents of the agreement demand \mathring{7} from the domain information managing unit 15, and prepares and notifies a new agreement demand \mathring{8} for the associated server 2 to the agreement renewal unit 14.

4. The agreement renewal unit 14 acquires, from the domain information managing unit 15, the agreement with the server 2 associated with the information obtained from the inter-domain cooperating unit 17, for the renewal.

5. The agreement renewal unit 14 transmits the agreement demand \mathring{7} for the server 2 from the transmitting unit 13 (claim 9).

Thereafter, the operations \mathring{1}-\mathring{6} shown in FIG. 9 are to be executed.

Thus, the present invention [3] enables the automatic agreement regarding a service between domains by adding the agreement renewal unit 14, the domain information managing unit 15, and inter-domain cooperating unit 17 and confirming the demand of agreement with another domain based on the agreement contents upon concluding an agreement.

FIG. 11 shows a schematic arrangement of the server 3 according to the present invention [4]. This arrangement is different from that of the present invention [3] shown in FIG. 8 in that a threshold judging unit 18 having the following functions is substituted for the inter-domain cooperating unit 17:

Threshold judging unit 18:

This cooperates with the agreement renewal unit 14 to suppress frequent change of the associated agreement contents with some threshold value in accordance with the change of an agreement contents.

The server 3 according to the present invention [4] of such an arrangement performs the following operations as shown FIG. 12:

1. The server 3 receives at the receiving unit 11 a message, which corresponds to the agreement change notifications \mathring{1} and \mathring{2} respectively of bandwidth guarantee of “2 Mbps” and “3 Mbps” in the example shown, from the server 2 on the agreement offering side regarding some agreement, and provides it to the agreement renewal unit 14.

2. The agreement renewal unit 14 notifies the contents of the agreement change notifications \mathring{1} and \mathring{2} to the threshold judging unit 18.

3. The threshold judging unit 18 acquires the information concerning the agreement change notifications \mathring{1} and \mathring{2} from the domain information managing unit 15, and judges whether or not agreement renewal should be made with respect to the agreement change notifications \mathring{1} and \mathring{2} by using a threshold value of “5 Mbps” stored therein to notify the judged result to the agreement renewal unit 14.

4. The agreement renewal unit 14 prepares an agreement offer if the agreement renewal is allowable, that is over “5 Mbps”, but otherwise does not prepare the agreement offer if the agreement renewal is unallowable, that is below “5 Mbps”, based on the judged result from the threshold judging unit 18. In the former case, the agreement renewal unit 18 renews the data of the domain information managing unit 15 to notify the message to the transmitting unit 13.

5. If the agreement renewal unit 14 notifies the agreement offer to the transmitting unit 13, the transmitting unit 13 transmits the message of the agreement offer \mathring{3} of the bandwidth guarantee of “5 Mbps” to the to server 1 on the agreement demanding side (claim 10).

Namely, the present inventions [1]-[3] as above noted always transfer the information to the server having the associated agreement during variations of network state or of agreement contents so that there is a possibility of a large number of messages associated with the agreement flowing over communication paths, whereas the present invention [4] can prevent the message regarding the agreement from being frequently transmitted, in the presence of the threshold judging unit 18 by using a threshold value as a judging reference for the agreement renewal unit 14 to execute the agreement renewal.

### BRIEF DESCRIPTION OF THE DRAWINGS

FIG. 1 is a block diagram showing a general network arrangement including the present invention;

FIG. 2 is a block diagram showing a schematic arrangement of the present invention [1];

FIG. 3 is a block diagram showing a schematic operation sequence (1) of the present invention [1];

FIG. 4 is a block diagram showing a schematic operation sequence (2) of the present invention [1];

FIG. 5 is a block diagram showing a schematic arrangement of the present invention [2 ];

FIG. 6 is a block diagram showing a schematic operation sequence (1) of the present invention [2];

FIG. 7 is a block diagram showing a schematic operation sequence (2) of the present invention [2];

FIG. 8 is a block diagram showing a schematic arrangement of the present invention [3];

FIG. 9 is a block diagram showing a schematic operation sequence (1) of the present invention [3];

FIG. 10 is a block diagram showing a schematic operation sequence (2) of the present invention [3];

FIG. 11 is a block diagram showing a schematic arrangement of the present invention [4];

FIG. 12 is a block diagram showing a schematic operation sequence of the present invention [4];

FIG. 13 is a sequence diagram of an embodiment (1) of the present invention;

FIG. 14 is a block diagram showing an arrangement of the embodiment (1) of the present invention;

FIG. 15 is a flow chart of an agreement renewal unit in a server 3 of the embodiment (1) of the present invention;

FIG. 16 is a flow chart of a domain information managing unit in the server 3 of the embodiment (1) of the present invention;

FIG. 17 is a flow chart of an agreement unit of policy servers 1 and 2 used in the present invention and the prior art;

FIG. 18 is a flow chart showing a specific example of a subroutine S22 in FIG. 17;

FIG. 19 is a flow chart showing a specific example of a subroutine S24 in FIG. 17;

FIG. 20 is a flow chart showing a specific example of a subroutine S26 in FIG. 17;

FIG. 21 is a flow chart showing a specific example of a subroutine S28 in FIG. 17;

FIG. 22 is a flow chart showing a specific example of a subroutine S31 in FIG. 17;

FIG. 23 is a flow chart showing a specific example of a subroutine S33 in FIG. 17;

FIG. 24 is a flow chart showing a specific example of a subroutine S35 in FIG. 17;

FIG. 25 is a flow chart showing a specific example of a subroutine S37 in FIG. 17;

FIG. 26 is a flow chart showing a specific example of a subroutine S39 in FIG. 17;

FIG. 27 is a flow chart showing a specific example of a subroutine S41 in FIG. 17;

FIG. 28 is a sequence diagram of an embodiment (2) of the present invention;

FIG. 29 is a block diagram showing an arrangement of the embodiment (2) of the present invention;

FIG. 30 is a flow chart of an agreement renewal unit in a server 3 of the embodiment (2) of the present invention;

FIG. 31 is a flow chart of a domain information managing unit in the server 3 of the embodiment (2) of the present invention;

FIG. 32 is a sequence diagram of an embodiment (3) of the present invention;

FIG. 33 is a block diagram showing an arrangement of the embodiment (3) of the present invention;

FIG. 34 is a flow chart of an agreement renewal unit in a server 3 in embodiments (3) and (4) of the present invention;

FIG. 35 is a flow chart of a specific example (1) of a subroutine S101 in FIG. 34;

FIG. 36 is a flow chart of a domain information managing unit in the server 3 of the embodiments (3) and (4) of the present invention;

FIG. 37 is a flow chart showing a specific example of a subroutine S111 in FIG. 36;

FIG. 38 is a flow chart of a network information collecting unit in the server 3 in the embodiments (3) and (4) of the present invention;

FIG. 39 is a sequence diagram of an embodiment (4) of the present invention;

FIG. 40 is a block diagram showing an arrangement of the embodiment (4) of the present invention;

FIG. 41 is a flow chart showing a specific example (2) of a subroutine S101 in FIG. 34;

FIG. 42 is a block diagram showing an arrangement of an embodiment (5) of the present invention;

FIG. 43 is a flow chart of an agreement renewal unit in a server 3 of embodiments (5) and (6) of the present invention;

FIG. 44 is a flow chart of a domain information managing unit in the server 3 of the embodiments (5) and (6) of the present invention;

FIG. 45 is a flow chart of an inter-domain cooperating unit in the server 3 of the embodiments (5) and (6) of the present invention;

FIG. 46 is a flow chart showing a specific example of a subroutine S153 in FIG. 45;

FIG. 47 is a flow chart showing a specific example of a subroutine S155 in FIG. 45;

FIG. 48 is a flow chart showing a specific example of a subroutine S157 in FIG. 45;

FIG. 49 is a flow chart showing a specific example of a subroutine S159 in FIG. 45;

FIG. 50 is a flow chart showing a specific example of a subroutine S161 in FIG. 45;

FIG. 51 is a block diagram showing an arrangement of an embodiment (6) of the present invention;

FIG. 52 is a sequence diagram of an embodiment (7) of the present invention;

FIG. 53 is a block diagram showing an arrangement of the embodiment (7) of the present invention;

FIG. 54 is a flow chart of an agreement renewal unit in a server 3 of the embodiment (7) of the present invention;

FIG. 55 is a flow chart of a domain information managing unit in the server 3 of the embodiment (7) of the present invention;

FIG. 56 is a flow chart of a threshold judging unit in the server 3 of the embodiment (7) of the present invention;

FIG. 57 is a diagram (1) for illustrating the prior art where a manager makes a manual agreement;

FIG. 58 is a diagram (2) for illustrating the prior art where agreement is automatically made between policy servers;

FIG. 59 is a block diagram showing an arrangement of a prior art server;

FIG. 60 is a diagram for illustrating an issue (1) of the prior art; and

FIG. 61 is a diagram for illustrating an issue (2) of the prior art.

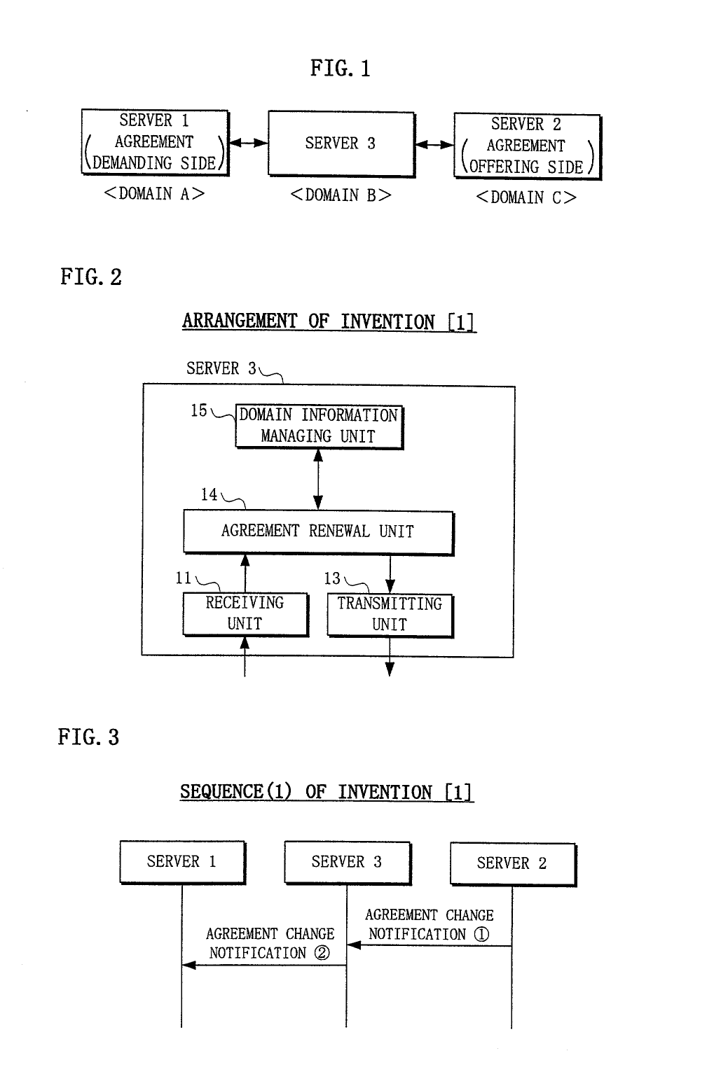

Throughout the figures, the same reference numerals indicate identical or corresponding portions.

### DESCRIPTION OF THE EMBODIMENTS

Embodiments of the present inventions [1]-[4] as above noted will be hereinafter described specifically.

Embodiment (1) which Corresponds to the Schematic Operation Sequence (1) of the Present Invention [1]

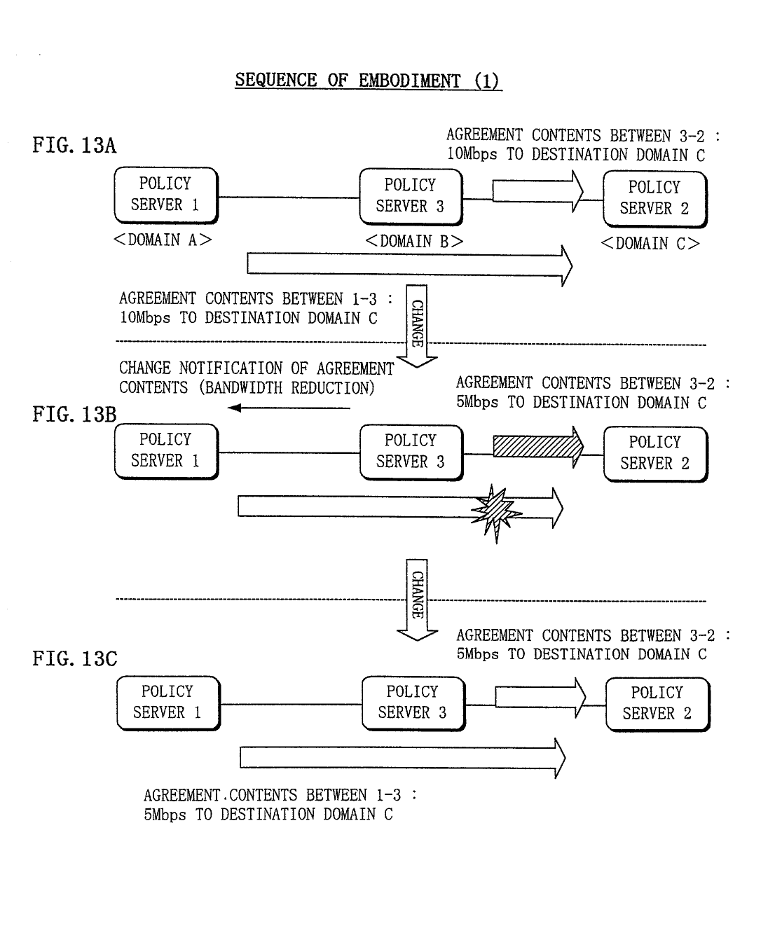

FIG. 13 schematically shows an embodiment (1) of the present invention which particularly corresponds to the schematic operation sequence (1) of the present invention [1] shown in FIG. 3. Namely, it is hereby supposed that the policy server 3, which will be hereinafter referred to simply as a server, has an agreement regarding a bandwidth guarantee of 10 Mbps respectively with the servers 1 and 2 as shown in FIG. 13A.

In this state, as shown in FIG. 13B, if the server 3 has already made an agreement change to a bandwidth guarantee of 5 Mbps with the server 2 on the agreement offering side in response to the agreement change notification \mathring{1} (see FIG. 3), the server 3 will lose the communication by the bandwidth guarantee with the server 1 unless the agreement contents are changed to the bandwidth of 5 Mbps even with respect to the server 1.

Accordingly, as shown in FIG. 13C, the server 3 provides an agreement change notification for the bandwidth of 5 Mbps to the server 2, thereby realizing the bandwidth guarantee between the servers 1-2.

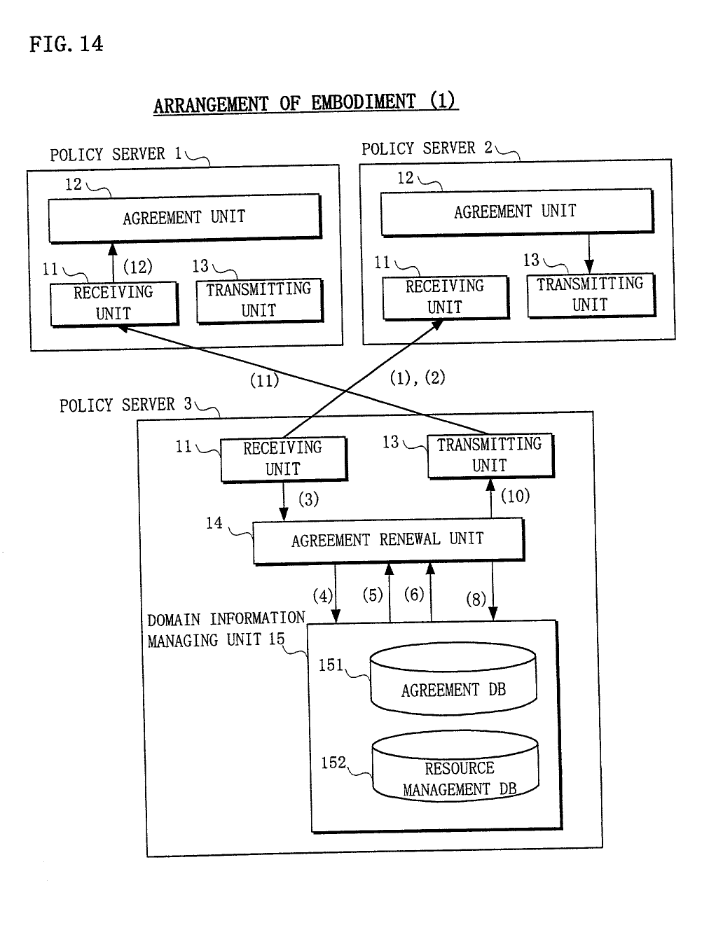

FIG. 14 shows arrangements of the servers 1-3 carrying out the above embodiment (1), each of which has the following functions:

Server 1, 2:

Function of automatically making an agreement.

Server 3 (agreement renewal apparatus):

Function of automatically making an agreement.

Function of renewing other agreements followed by the change of agreement by means of the agreement renewal unit 14 and the domain information managing unit 15. It is to be noted that the domain information managing unit 15 includes an agreement database (DB) 151 and a resource management database 152.

In this embodiment (1), the IP address and managing subnet of each server are determined as shown in the following Table 1, where the following description will omit “24” of the managing subnet:

TABLE 1

| | | MANAGING |
|---|---|---|
| NAME | IP ADDRESS | SUBNET |
| SERVER 1 | 10.10.10.1 | 10.10.10.0/24 |
| SERVER 3 | 10.10.20.1 | 10.10.20.0/24 |
| SERVER 2 | 10.10.30.1 | 10.10.30.0/24 |

It is also supposed that the server 3 has already made an agreement as shown in the following tables with the servers 1 and 2:

TABLE 2
AGREEMENT CONTENTS OF SERVER 1

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 2 | 10.10.20.1 | 10.10.10.1 | 10 | 2000 | 10.10.30.0 |

TABLE 3
AGREEMENT CONTENTS OF SERVER 3

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 1 | 10.10.30.1 | 10.10.20.1 | 10 | 1000 | 10.10.30.0 |
| 2 | 10.10.20.1 | 10.10.10.1 | 10 | 2000 | 10.10.30.0 |

TABLE 4
AGREEMENT CONTENTS OF SERVER 4

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 1 | 10.10.30.1 | 10.10.20.1 | 10 | 1000 | 10.10.30.0 |

It is to be noted that “ID” indicates an identification for discriminating agreements made between servers, “bandwidth” indicates a guarantee bandwidth having a unit of Mbps for the communication, “account” indicates a price of agreement having a unit of Yen, and “destination address” indicates a destination of communication.

Also, “Offering IP” indicates an IP address of a server in a domain (domain C in this example) offering a service, and “Demanding IP” indicates an IP address of a server in a domain (domain A in this example) demanding a service, by the agreement.

The server 3 holds therein a resource management DB 152 of its own domain B shown in the following table:

TABLE 5
SOURCE MANAGEMENT DB OF SERVER 3

| | ACCOUNT | |
|---|---|---|
| BANDWIDTH (Mbps) | (YEN) | DESTINATION ADDRESS |
| 10 | 1000 | 10.10.20.0 |
| 10 | 1000 | 10.10.30.0 |

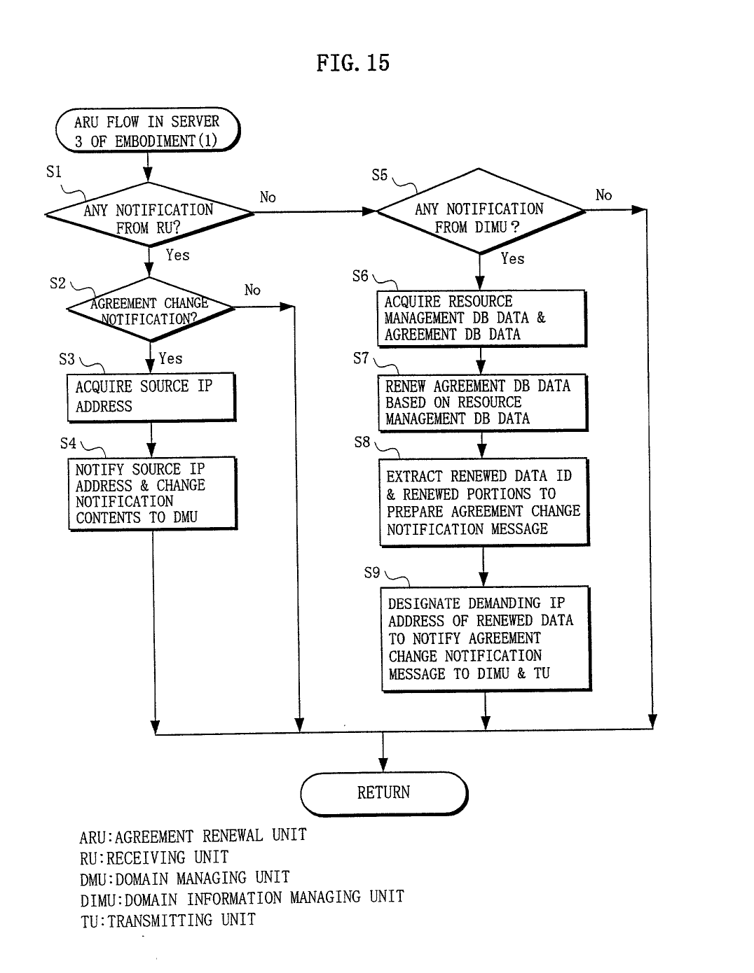

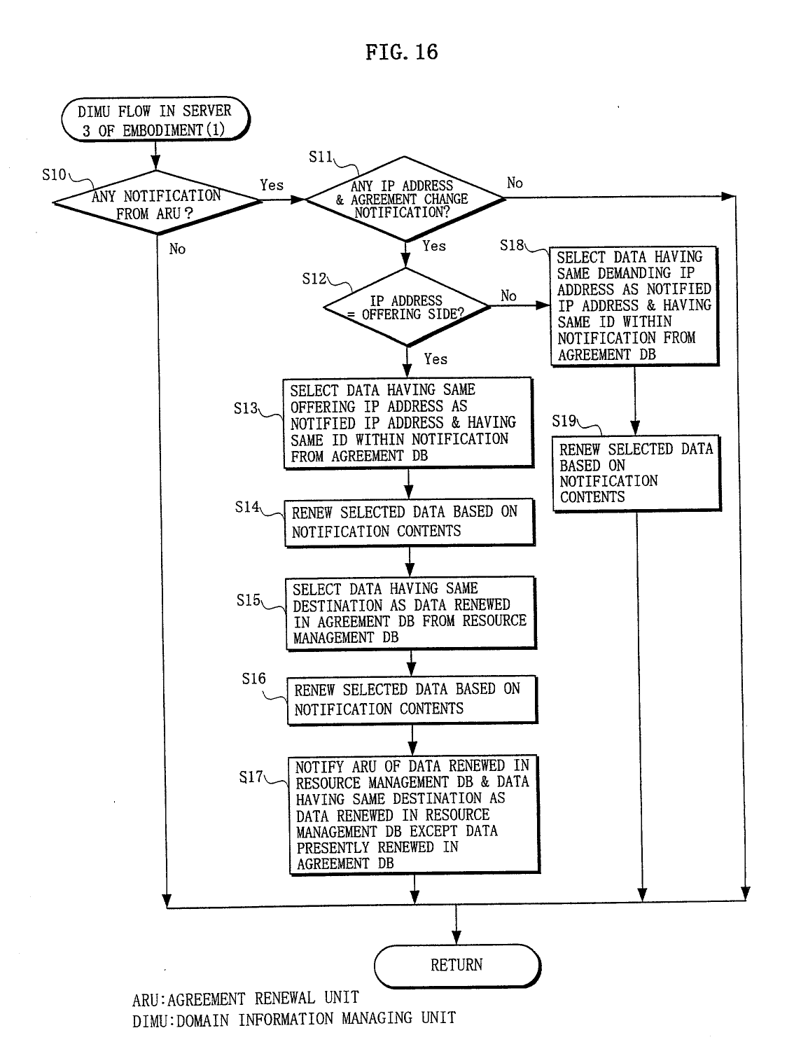

By the following sequence of this embodiment, the renewal of agreement contents is executed depending on a change of agreement (see flow charts of FIGS. 3, 15, and 16).

(1) From the server 2, the data of the agreement change notification \mathring{1} (see FIG. 3) shown in the following table are transmitted to the server 3, which serve to change the bandwidth from “10 Mbps” to “5 Mbps”:

TABLE 6

| | | BANDWIDTH | ACCOUNT | DESTINATION |
|---|---|---|---|---|
| FLAG | ID | (Mbps) | (YEN) | ADDRESS |
| 5 | 1 | 5 | | |

It is to be noted that “Flag” indicates a kind of message regarding respective agreements such that the agreement demand is “0” (no ID), the agreement decision demand is “1” (no ID), the agreement change demand is “2” (no account/destination), the agreement offer is “3” (no ID), the agreement decision response is “4” (all numerical values exist), and the agreement change notification is “5” (no destination) while a plurality of identical flag data may be stored in a single message. The case where both of the agreement change demand and the agreement change notification have no numerical value for the bandwidth and the account means an agreement suspension.

(2) The server 3 receives the notification at the receiving unit 11, and acquires an IP address (10.10.30.1) of the source server 2.

(3) The receiving unit 11 transmits agreement change notification data to the agreement renewal unit 14 with the offering IP address being made “10.10.30.1” (steps S1-S3).

(4) The agreement renewal unit 14 notifies an information renewal and information retrieval to the domain information managing unit 15 (step S4).

(5) The domain management unit 15 renews the agreement DB 151 and the source management DB 152 based on the ID as shown in the following tables (steps S10-S16):

TABLE 7
AGREEMENT DB

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 1 | 10.10.30.1 | 10.10.20.1 | 5 | 1000 | 10.10.30.0 |
| 2 | 10.10.20.1 | 10.10.10.1 | 10 | 2000 | 10.10.30.0 |

TABLE 8
SOURCE MANAGEMENT DB

| | ACCOUNT | |
|---|---|---|
| BANDWIDTH (Mbps) | (YEN) | DESTINATION ADDRESS |
| 10 | 1000 | 10.10.20.0 |
| 5 | 1000 | 10.10.30.0 |

(6) The domain information managing unit 15 notifies to the agreement renewal unit 14 data, having the same destination net address except renewed data, associated with an agreement change after the renewal (step S17). The notification data are shown in the following tables:

TABLE 9
AGREEMENT DATA

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 2 | 10.10.20.1 | 10.10.10.1 | 10 | 2000 | 10.10.30.0 |

TABLE 10
SOURCE MANAGEMENT DATA

| | ACCOUNT | |
|---|---|---|
| BANDWIDTH (Mbps) | (YEN) | DESTINATION ADDRESS |
| 5 | 1000 | 10.10.30.0 |

(7) The agreement renewal unit 14 compares the bandwidths of supply data and demand data to determine an agreement to be changed as shown in the following tables (steps S5-S8):

TABLE 11
BEFORE CHANGE

| | OFFERING | DEMANDING | BANDWIDTH | ACCOUNT | DESTINATION |
|---|---|---|---|---|---|
| ID | IP | IP | (Mbps) | (YEN) | ADDRESS |
| 2 | 10.10.20.1 | 10.10.10.1 | 10 | 2000 | 10.10.30.0 |

TABLE 12
AFTER CHANGE

| | OFFERING | DEMANDING | BANDWIDTH | ACCOUNT | DESTINATION |
|---|---|---|---|---|---|
| ID | IP | IP | (Mbps) | (YEN) | ADDRESS |
| 2 | 10.10.20.1 | 10.10.10.1 | 5 | 2000 | 10.10.30.0 |

It is seen from this example that the bandwidth is required to be changed to 5 Mbps regarding the agreement contents of ID=2.

(8) The agreement renewal unit 14 provides a data renewal notification shown in the following table to the domain information managing unit 15 with the demanding IP address being made “10.10.10.1” (step S9):

TABLE 13
NOTIFICATION DATA

| | BANDWIDTH | ACCOUNT | DESTINATION |
|---|---|---|---|
| ID | (Mbps) | (YEN) | ADDRESS |
| 2 | 5 | | |

(9) The domain information managing unit 15 renews the agreement DB 151 based on the notified data as shown in the following table:

TABLE 14
AGREEMENT DB

| | OFFERING | DEMANDING | BANDWIDTH | ACCOUNT | DESTINATION |
|---|---|---|---|---|---|
| ID | IP | IP | (Mbps) | (YEN) | ADDRESS |
| 1 | 10.10.30.1 | 5 | 10.10.20.15 | 1000 | 10.10.30.0 |
| 2 | 10.10.20.1 | 5 | 10.10.10.15 | 2000 | 10.10.30.0 |

(10) The agreement renewal unit 14 prepares a message of the agreement change notification \mathring{2} (see FIG. 3) based on change potions of the agreement with the destination address being made “10.20.10.1” as shown in the following table, and transmits it at the transmitting unit 13:

TABLE 15

| | BANDWIDTH | ACCOUNT | DESTINATION |
|---|---|---|---|
| ID | (Mbps) | (YEN) | ADDRESS |
| 2 | 5 | | |

(11) The transmitting unit 13 transmits the agreement change notification message to the server 1 of the destination IP address (10.20.10.1) designated.

(12) The server 1 having received the message of the agreement change notification \mathring{2} confirms the change of the agreement contents to enew the agreement made with the server 3 as shown in the following table:

TABLE 16
AGREEMENT CONTENTS OF SERVER 1

| | OFFERING | DEMANDING | BANDWIDTH | ACCOUNT | DESTINATION |
|---|---|---|---|---|---|
| ID | IP | IP | (Mbps) | (YEN) | ADDRESS |
| 2 | 10.10.20.1 | 10.10.10.1 | 5 | 2000 | 10.10.30.0 |

Thus, the server 3 enables the agreement with the server 1 to be automatically changed based on the change regarding the agreement with the server 2.

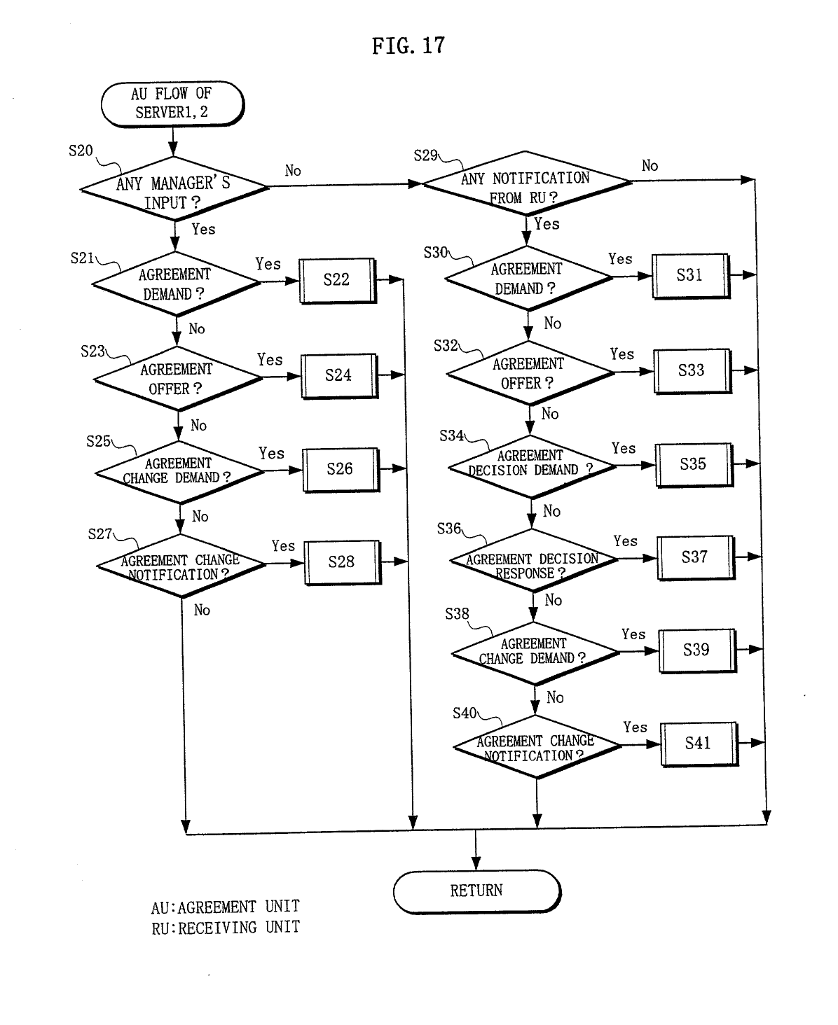

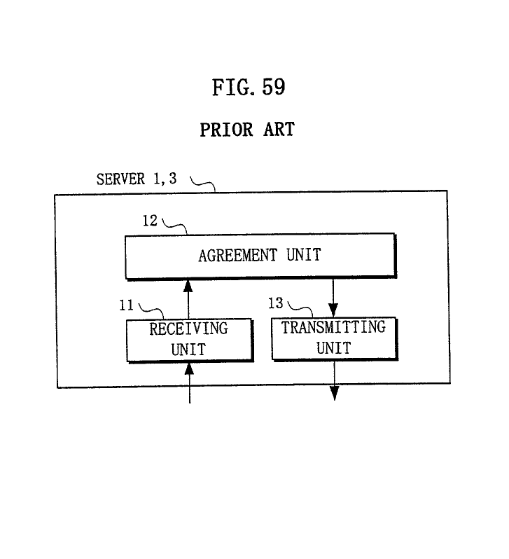

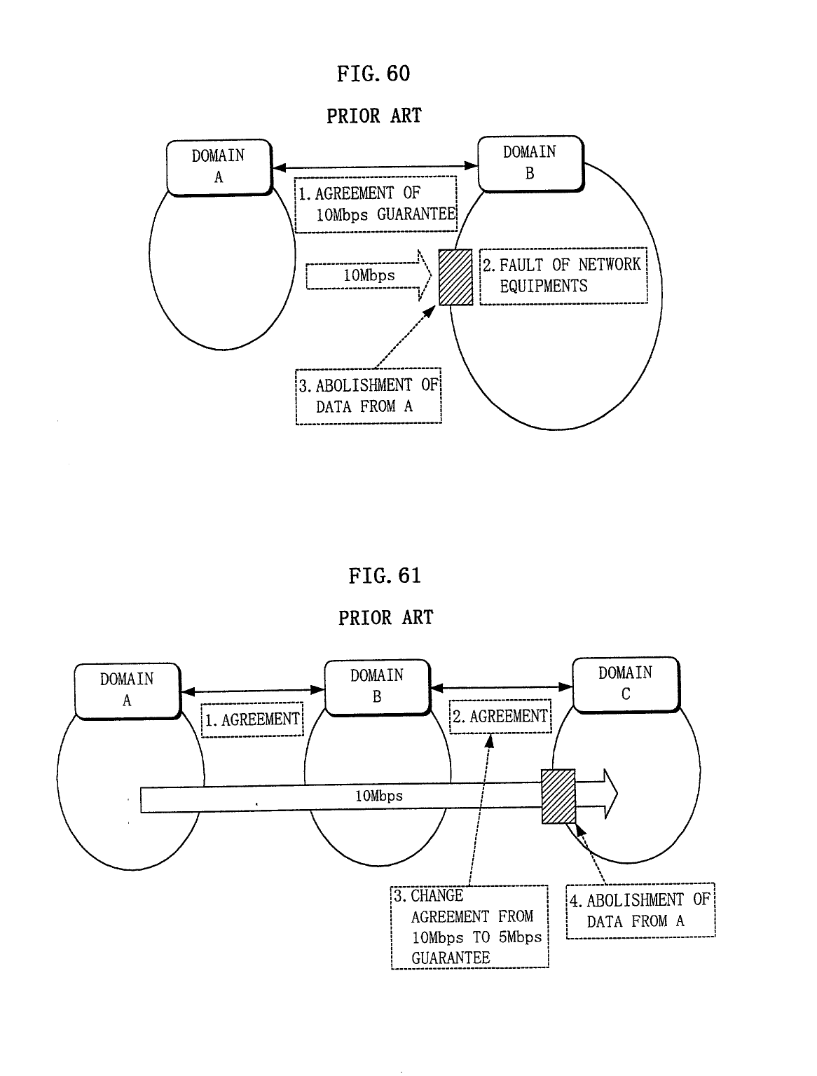

Now, the agreement unit (see FIG. 59 ) of the server 1 or 2 will be described referring to FIGS. 17-27.

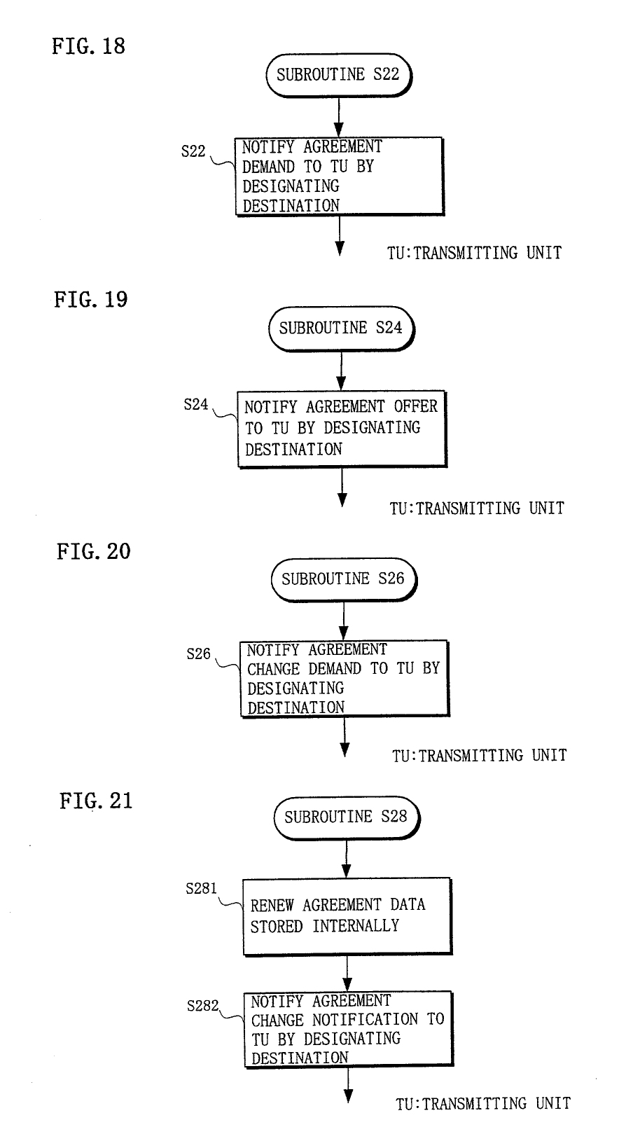

It is checked whether or not there is an input by a manager (step S20). If it is the case, it is then checked whether or not the agreement demand is present. In the presence of the agreement demand, a subroutine S22 shown in FIG. 18 will be executed.

In this subroutine S22, the agreement demand is notified to the transmitting unit 13 by designating the destination, that is, data of flag, bandwidth, account, designation net address, and designation IP address are designated based on the information inputted by the manager.

If it is found at step S21 that the manager's input is not the agreement demand, then whether or not it is the agreement offer is checked (step S23). If it is found to be the agreement offer, the agreement offer is notified to the transmitting unit 13 by designating the destination by a subroutine S24 as shown in FIG. 19.

If it is found at step S23 that the manager's input is not the agreement offer, then whether or not it is the agreement change demand is checked (step S25). If it is the agreement change demand, a subroutine S26 is executed.

By this subroutine S26, as shown in FIG. 20, the agreement change demand is notified to the transmitting unit 13 by designating the destination.

If it is found at step S25 that the manager's input is not the agreement change demand, then whether or not it is the agreement change notification is checked (step S27). If it is found to be the agreement change notification, a subroutine S28 is executed.

By this subroutine S28, as shown in FIG. 21, agreement data stored therein is firstly renewed at step S281, and then at step S282, the agreement change notification is notified to the transmitting unit 13 by designating the destination.

On the other hand, if it is found at step S20 that the input is not made by the manager, a step S29 is executed to check whether or not there is a notification from the receiving unit 11.

As a result, if it is found that there is a notification from the receiving unit 11 and at step S30 this notification is the agreement demand, a subroutine S31 is executed.

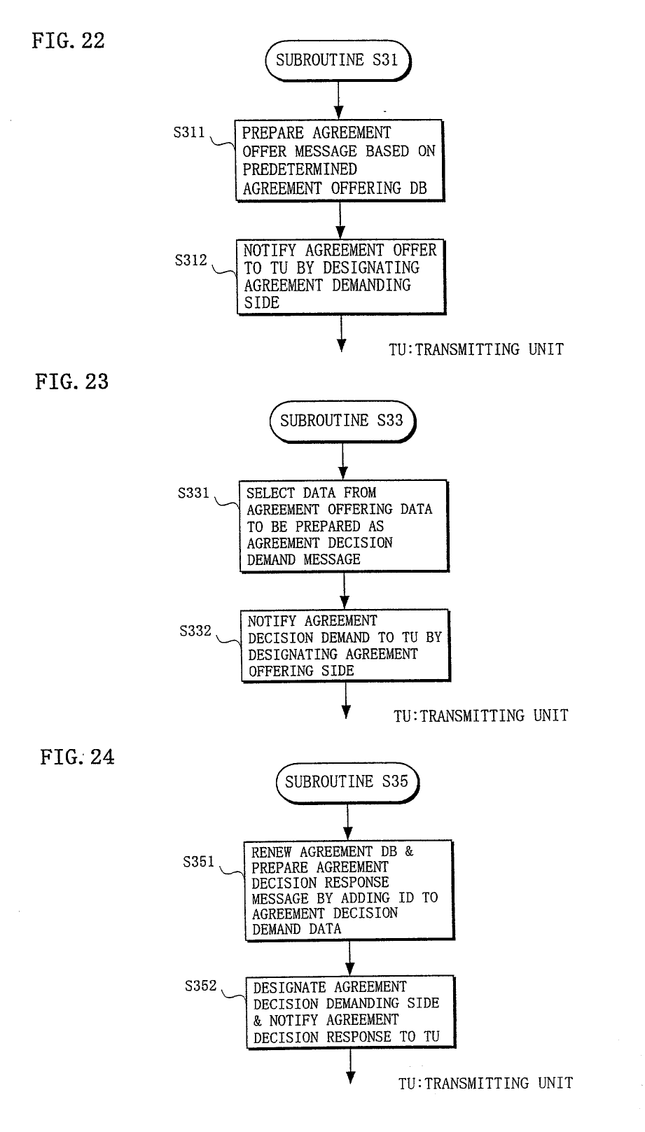

By this subroutine S31, as shown in FIG. 22, an agreement offer message is prepared based on a predetermined agreement offering database (step S311), and the agreement offer is notified to the transmitting unit 13 by designating the agreement demanding side (step S312).

If it is found at step S32 that the notification from the receiving unit 11 is not the agreement demand but the agreement offer, a subroutine S33 is executed.

By this subroutine S33, as shown FIG. 23, data are selected from the agreement offering data to prepare an agreement decision demand message (step S331), and the agreement decision demand is notified to the transmitting unit 13 by designating the agreement offering side (step S332).

If it is found at step S34 that the notification from the receiving unit 11 is the agreement decision demand, a subroutine S35 is executed.

By this subroutine S35, as shown in FIG. 24, the agreement database is renewed and an agreement decision response message is prepared by adding ID to the agreement decision demand data (step S351), and the agreement decision response is notified to the transmitting unit 13 by designating the agreement decision demand side (step S352).

If it is found at step S36 that the notification from the receiving unit 11 is the agreement decision response, a subroutine S37 is executed.

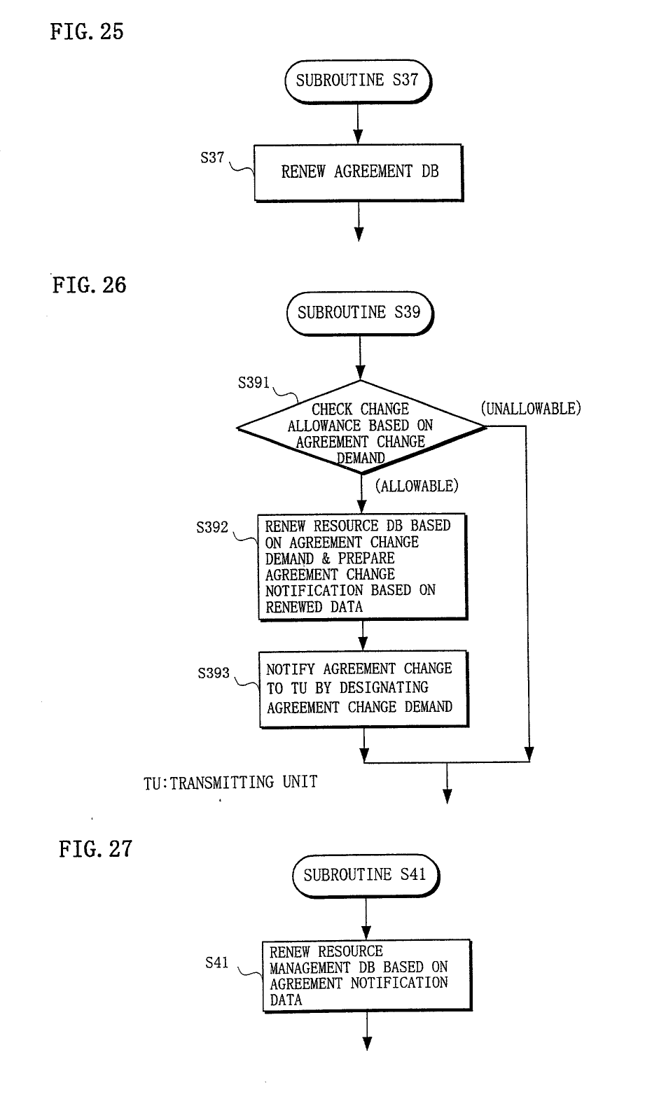

By this subroutine S37, as shown in FIG. 25, the agreement DB is renewed.

If it is further found at step S38 that the notification from the receiving unit 11 is the agreement change demand, a subroutine S39 is executed.

By this subroutine S39, as shown in FIG. 26, the agreement change demand is checked as to whether or not its change is allowable (step S391). For example, it is allowable in the case of an agreement cancellation demand. It is also allowable if the agreement contents after the change in the case of an agreement change demand are contained in the agreement offering data. Otherwise it is unallowable.

If it is found allowable, the resource management DB is renewed based on the agreement change demand, the agreement change notification is prepared based on the data renewed (step S392), and the agreement change notification is provided to the transmitting unit 13 by designating the agreement change demanding side (step S393).

If it is further found at step S40 that the notification from the receiving unit 11 is the agreement change notification, a subroutine S41 is executed.

By this subroutine S41, as shown in FIG. 27, the resource management DB is renewed based on the agreement change notification data.

It is to be noted that in the above embodiment, protocols such as Telnet, COPS, LDAP, SNMP may be used in addition to the protocol for performing the aforementioned sequence.

Also in the above embodiment, a database is held within a server while it may be held in an apparatus outside the server, not within the server, so that the server performs data access by means of a protocol such as LDAP whenever necessary.

Furthermore in the above embodiment, a network example using three servers is illustrated while an agreement renewal apparatus may be connected between servers, thereby making an agreement in a network having three or more servers. This applies to the following embodiments in the same manner.

Embodiment (2) Which Corresponds to the Schematic Operation Sequence (2) of the Present Invention [1]

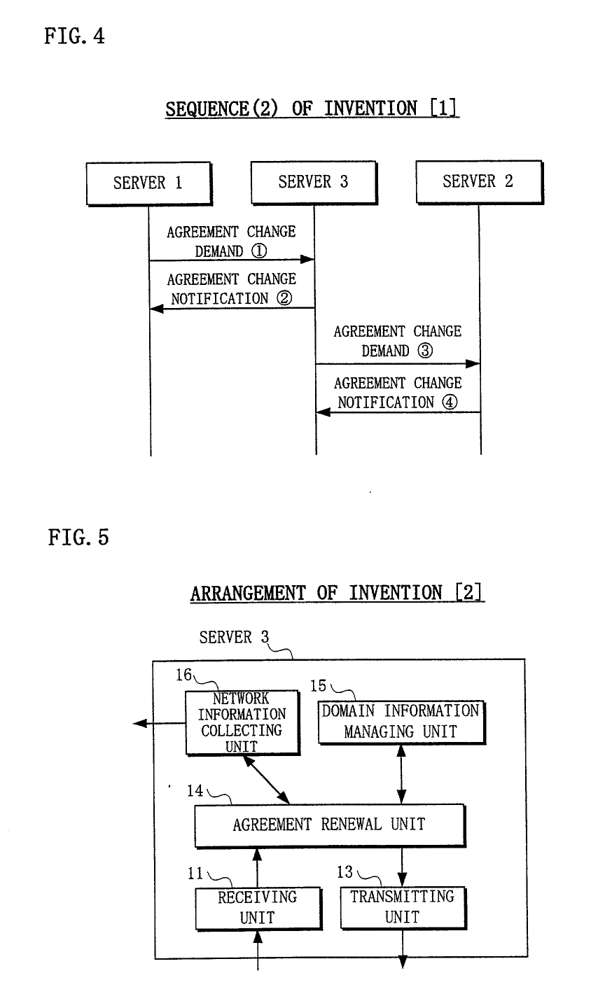

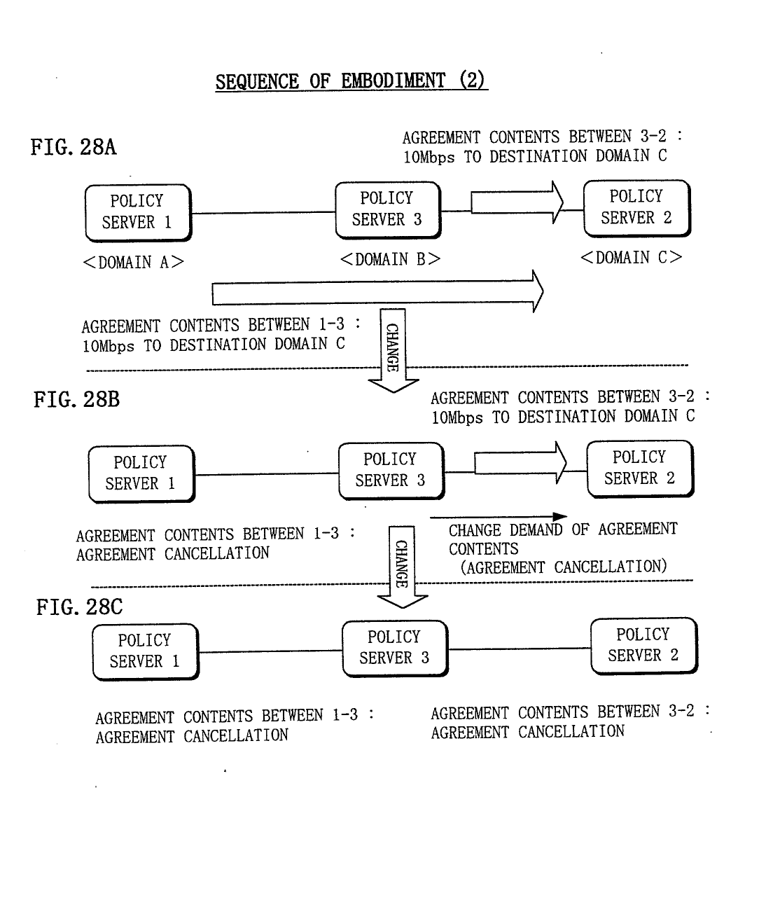

FIG. 28 schematically shows an embodiment (2) of the present invention, which particularly corresponds to the schematic operation sequence (2) of the present invention [1] shown in FIG. 4.

Namely, servers have an agreement regarding the bandwidth guarantee of 10 Mbps in the same manner as the embodiment (1) as shown in FIG. 28A.

When a change demand (agreement cancellation) \mathring{1} of agreement contents (see FIG. 4) is provided from the server 1 to the server 3, as shown in FIG. 28B, the server 3 makes a change demand (agreement cancellation) \mathring{3} of agreement contents (see FIG. 4) to the server 2 in the same manner.

This enables the agreement cancellation between the servers as shown in FIG. 28C and an automatic renewal of other agreements followed by the change of agreement.

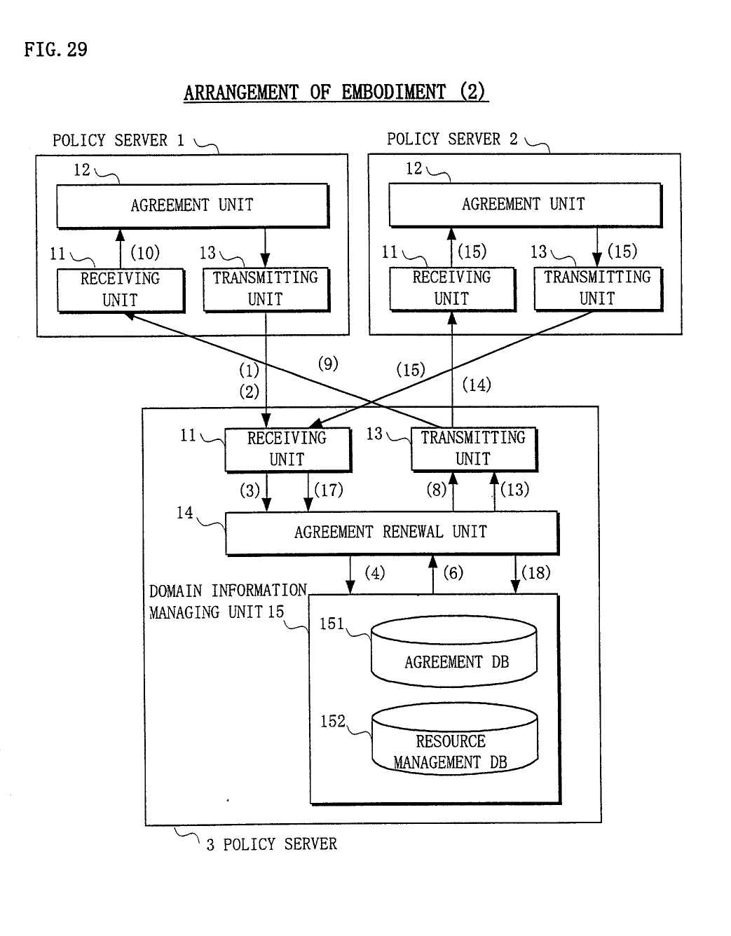

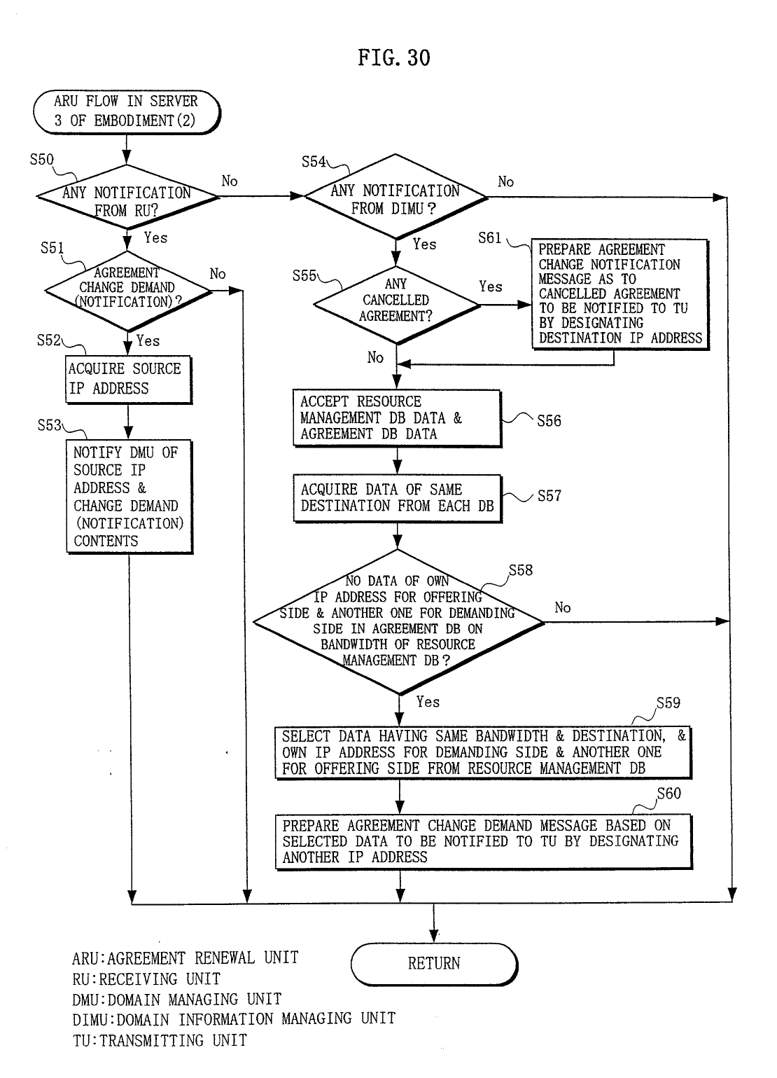

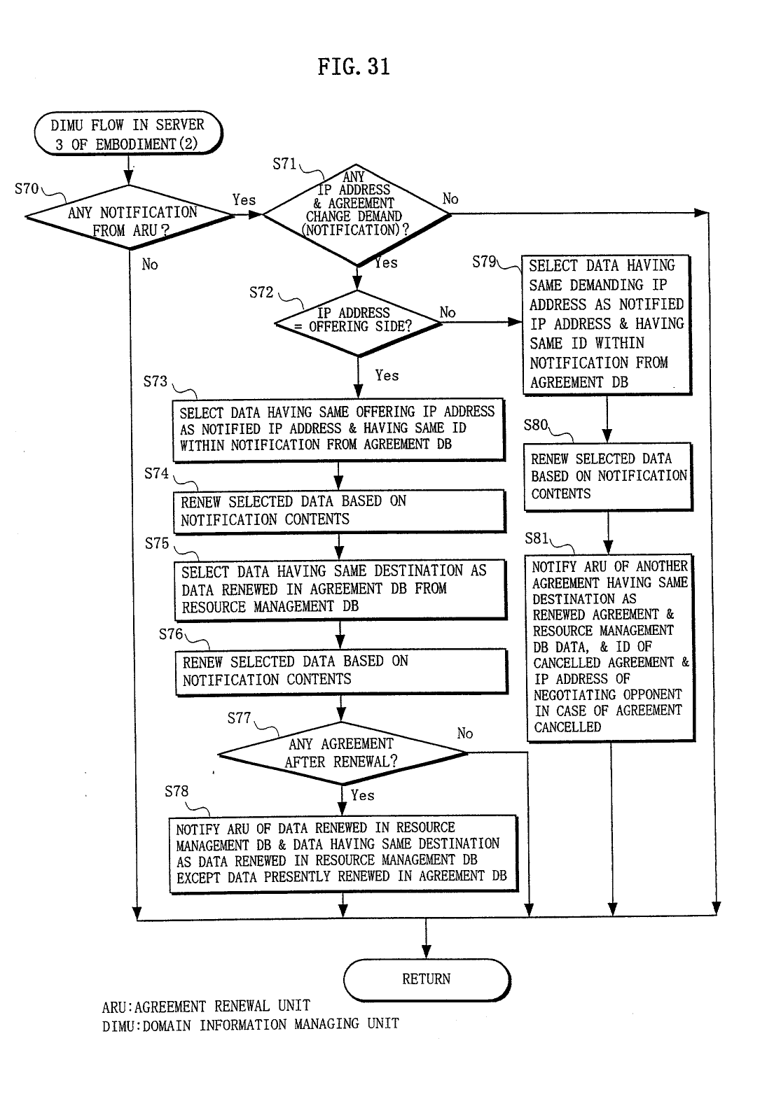

While FIG. 29 shows arrangements of the servers 1-3 for realizing the embodiment (2), the arrangements of the servers are the same as the embodiment (1) shown in FIG. 14 and the above tables 1-5 can be also applied to this embodiment, whereas operations are different as shown by reference numerals. These operations will now be sequentially described referring to flow charts of FIGS. 4, 30, and 31:

(1) The server 1 transmits to the server 3 data of an agreement change demand \mathring{1} (see FIG. 4) shown in the following table:

The contents of this agreement demand comprise “agreement cancellation.”

TABLE 17

| | | | | |
|---|---|---|---|---|
| | | BANDWIDTH | ACCOUNT | DESTINATION |
| FLAG | ID | (Mbps) | (YEN) | ADDRESS |

| | |
|---|---|
| 2 | 2 |

(2) Server 3 receives the agreement demand \mathring{1} at the receiving unit 11, and acquires an IP address (10.10.10.1) of the server 1 (source) on the agreement demanding side (steps S50-S52).

(3) The receiving unit 11 transmits data of agreement change demand to the agreement renewal unit 14 with the demanding IP address being “10.10.10.1”.

(4) The agreement renewal unit 14 notifies the domain information managing unit 15 of the information renewal and the information retrieval (step S53).

(5) The domain information managing unit 15 renews the agreement DB 151 and the resource management DB 152 based on the ID as shown in the following table (steps S79 and S80):

TABLE 18
AGREEMENT DB

| | OFFERING | DEMANDING | BANDWIDTH | ACCOUNT | DESTINATION |
|---|---|---|---|---|---|
| ID | IP | IP | (Mbps) | (YEN) | ADDRESS |
| 1 | 10.10.30.1 | 10.10.20.1 | 10 | 1000 | 10.10.30.0 |

TABLE 19
SOURCE MANAGEMENT DB

| | | DESTINATION |
|---|---|---|
| BANDWIDTH (Mbps) | ACCOUNT (YEN) | ADDRESS |
| 10 | 1000 | 10.10.20.0 |
| 10 | 1000 | 10.10.30.0 |

(6) The domain information managing unit 15 notifies the agreement renewal unit 14 of the data, having the same destination net address except renewed data, associated with the agreement change after the renewal, the ID=2 having canceled (suspended) the agreement, and the IP address (10.10.10.1) of the agreement object (step S81). These notification data are shown in the following tables:

TABLE 20
AGREEMENT DATA

| | OFFERING | DEMANDING | BANDWIDTH | ACCOUNT | DESTINATION |
|---|---|---|---|---|---|
| ID | IP | IP | (Mbps) | (YEN) | ADDRESS |
| 1 | 10.10.30.1 | 10.10.20.1 | 10 | 1000 | 10.10.30.0 |

TABLE 21
SOURCE MANAGEMENT DATA

| | ACCOUNT | |
|---|---|---|
| BANDWIDTH (Mbps) | (YEN) | DESTINATION ADDRESS |
| 10 | 1000 | 10.10.30.0 |

(7) The agreement renewal unit 14 prepares to the server 1 of the source (10.10.10.1) of the agreement change demand \mathring{1} a message of an agreement change notification \mathring{2} (see FIG. 4) as shown in the following table (step S61):

TABLE 22

| | | BANDWIDTH | ACCOUNT | DESTINATION |
|---|---|---|---|---|
| FLAG | ID | (Mbps) | (YEN) | ADDRESS |
| 5 | 2 | | | |

(8) The agreement renewal unit 14 notifies the message prepared to the transmitting unit 13 (step S61).

(9) The transmitting unit 13 transmits the agreement change notification message to the server 1 of the demanding IP address (10.10.10.1).

(10) In the server 1, the agreement change notification is received by the receiving unit 11, and the contents thereof are provided to the agreement unit 12, which at this point reflects the change with respect to the agreement between the servers 1 and 3.

(11) The agreement renewal unit 14 of the server 3 compares bandwidths of supply data and demand data to determine an agreement to be changed. Since the resource management DB 152 has data but the agreement DB 151 has no data for the resource to be consumed, the change of agreement regarding the resource is determined (steps S54-S58). In this embodiment, it is found necessary to change (cancel) the agreement contents of ID=1.

(12) The agreement renewal unit 14 prepares a message of an agreement change demand \mathring{3} (see FIG. 4) shown in the following table with the destination IP address being “10.10.30.1” (step S60):

TABLE 23

| | | | |
|---|---|---|---|
| | BANDWIDTH | ACCOUNT | DESTINATION |
| ID | (Mbps) | (YEN) | ADDRESS |

1

(13) The agreement renewal unit 14 notifies the transmitting unit 13 of the above message prepared (step S60).

(14) The transmitting unit 13 transmits the agreement change demand \mathring{3} (see FIG. 4) to the server 2 of the source IP address (10.10.30.1).

(15) The server 2 receives the agreement change demand from the server 3. The agreement unit 12 prepares an agreement change notification \mathring{4} (see FIG. 4) shown in the following table to the server 3, whereby the transmitting unit 13 transmits the agreement change notification \mathring{4}:

TABLE 24

| | | | | |
|---|---|---|---|---|
| | | BANDWIDTH | ACCOUNT | DESTINATION |
| FLAG | ID | (Mbps) | (YEN) | ADDRESS |

| | |
|---|---|
| 5 | 1 |

(16) The server 3 receives the agreement change notification at the receiving unit 11, and acquires the IP address (10.10.30.1) of the source server 2.

(17) The receiving unit 11 transmits the data of agreement change notification to the agreement renewal unit 14 with the offering IP address being made “10.10.30.1” (steps S50-S52).

(18) The agreement renewal unit 14 notifies the domain information managing unit 15 of the information renewal and the information retrieval (step S53).

(19) The domain information managing unit 15 renews the agreement DB 151 and the resource management DB 152 based on the ID's (steps S71-S76).

(20) The domain information managing unit 15 renews the DB's 151 and 152 based on the notified data as shown in the following tables, where no notification is provided to the agreement renewal unit 14 in the absence of the agreement contents (step S77):

TABLE 25
AGREEMENT DB

| | | | | | |
|---|---|---|---|---|---|
| | | DEMAND- | BAND | | DESTI- |
| | OFFERING | ING | WIDTH | ACCOUNT | NATION |
| ID | IP | IP | (Mbps) | (YEN) | ADDRESS |

TABLE 26
SOURCE MANAGEMENT DB

| | ACCOUNT | |
|---|---|---|
| BANDWIDTH (Mbps) | (YEN) | DESTINATION ADDRESS |
| 10 | 1000 | 10.10.20.0 |

Thus, the server 3 can change the agreement with the server 2 based on the change regarding the agreement with the server 1.

Embodiment (3) which Corresponds to the Schematic Operation Sequence (1) of the Present Invention [2]

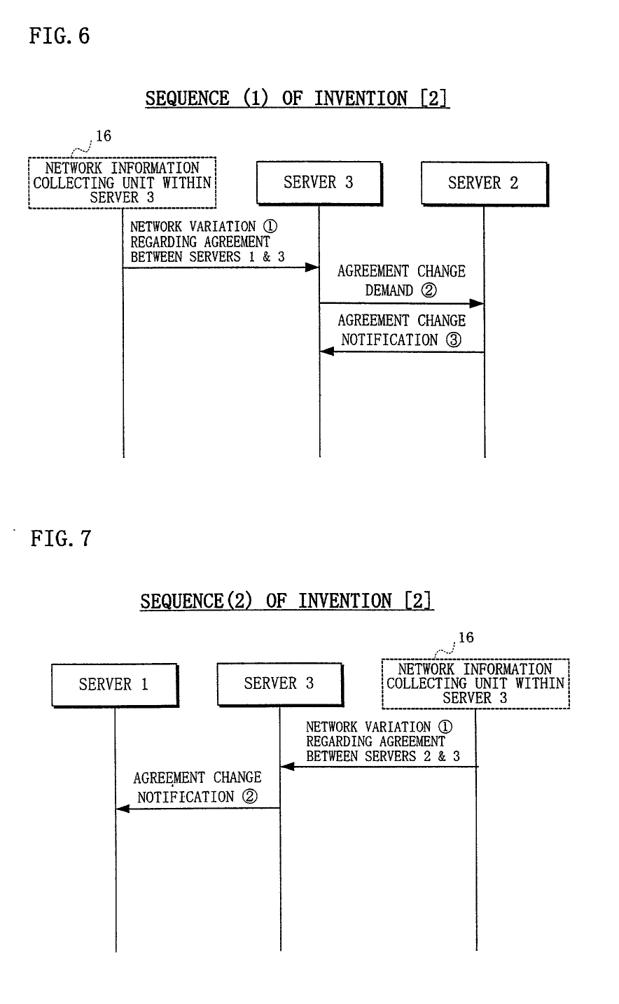

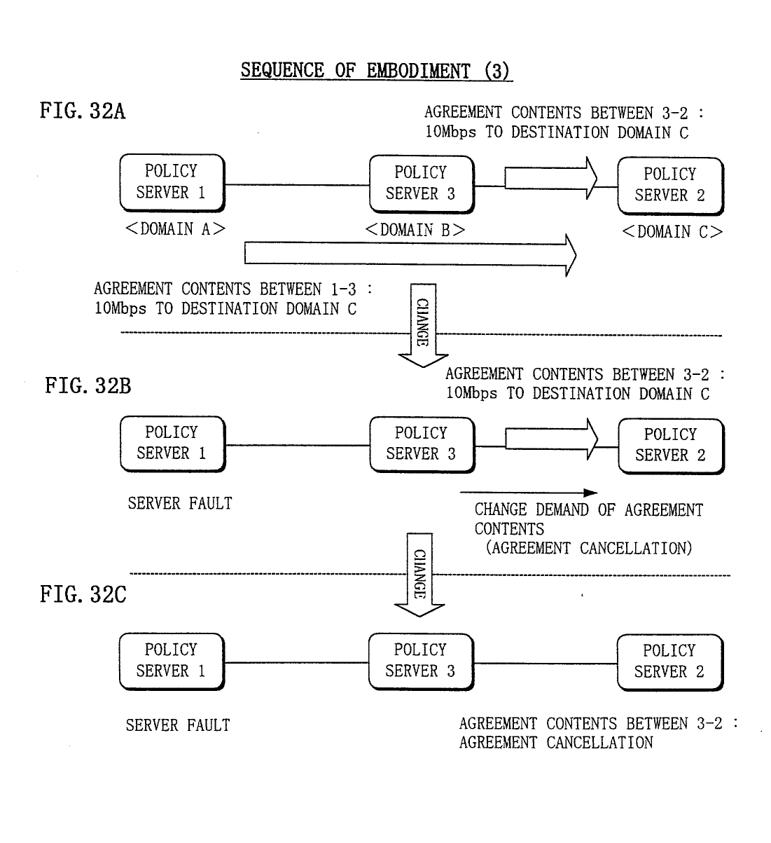

FIG. 32 schematically shows an embodiment (3) of the present invention, which particularly corresponds to the schematic operation sequence (1) of present invention [2] shown in FIG. 6.

Namely, in the state where the servers 1-3 have an agreement for the bandwidth guarantee of 10 Mbps as shown in FIG. 32A, when for example as shown in FIG. 32B the server 3 detects the change of another agreement (other agreements) followed by a change of network state regarding agreement such as a fault of the server 1 on the agreement demanding side, an agreement change demand (agreement suspension) is made to the server 2 associated with the agreement. As a result, as shown in FIG. 32C, the agreement between the servers 3-2 is to be canceled, enabling automatic renewal of agreement followed by the change of network state.

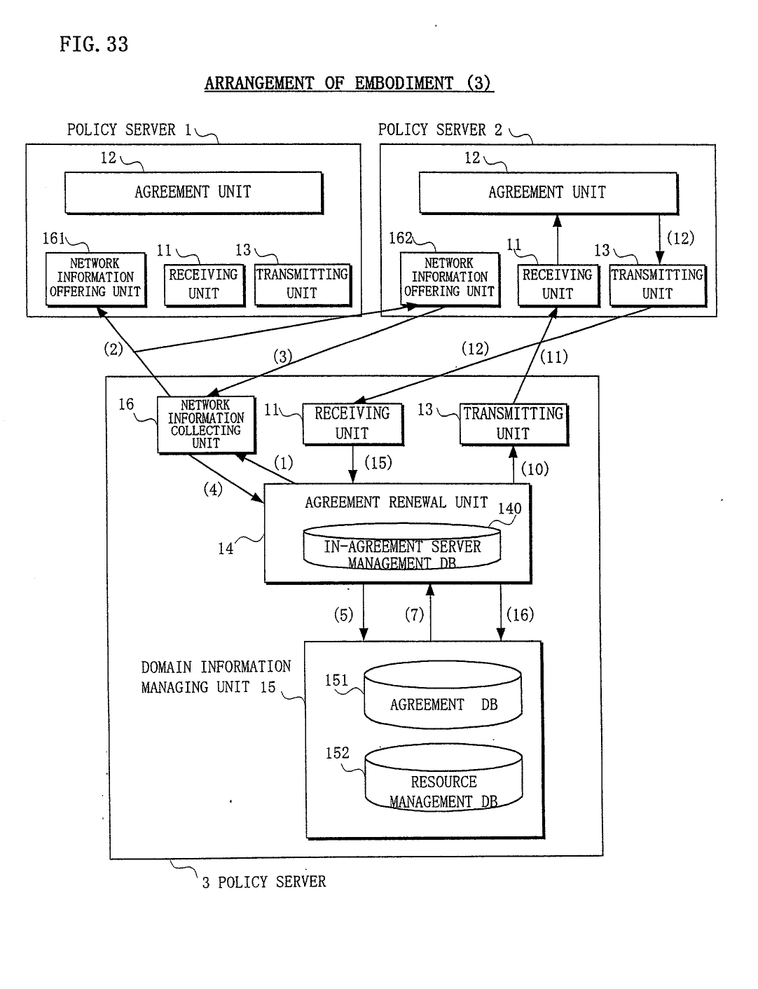

While FIG. 33 shows arrangements of the server 1-3 for realizing the embodiment (3) in which a network information collecting unit 16 is provided in the server 3 as shown in FIG. 5, and the servers 1 and 2 are respectively provided with network information offering units 161 and 162 for enabling a mutual communication with the network information collecting unit 16. The other arrangements thereof are similar to the embodiment (2), and the above tables 1-5 are similarly applied.

It is now supposed that the agreement renewal unit 14 preliminarily holds the IP address of an opponent having received or transmitted an agreement decision response, in an in-agreement server management DB 140 as shown in the following table:

TABLE 27
IN-AGREEMENT SERVER MANAGEMENT DB

IN-AGREEMENT SERVER IP ADDRESS
10.10.10.1
10.10.30.1

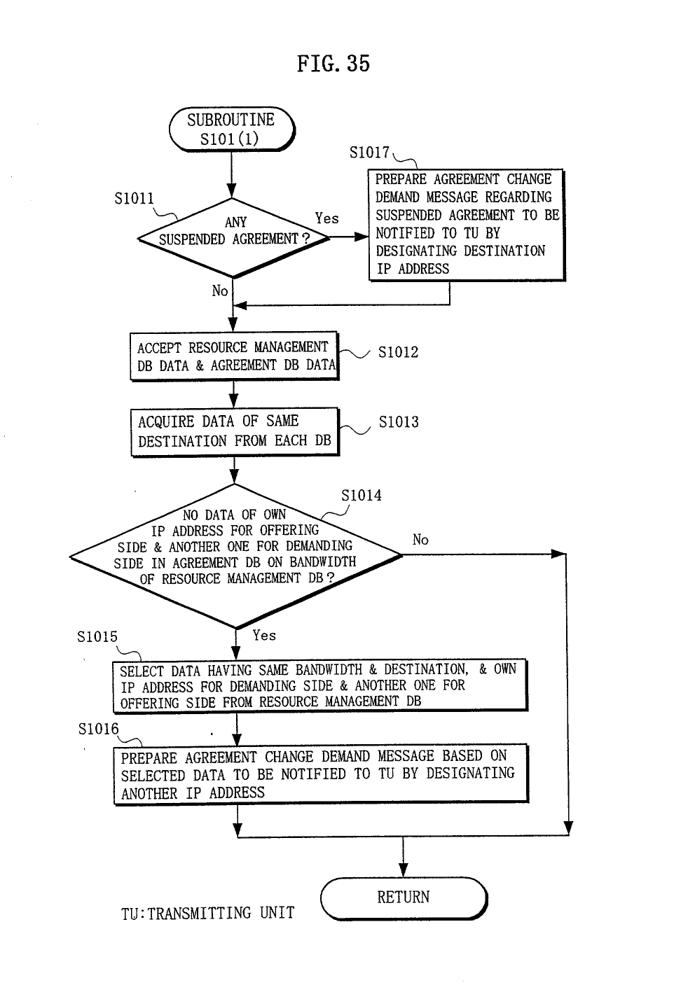

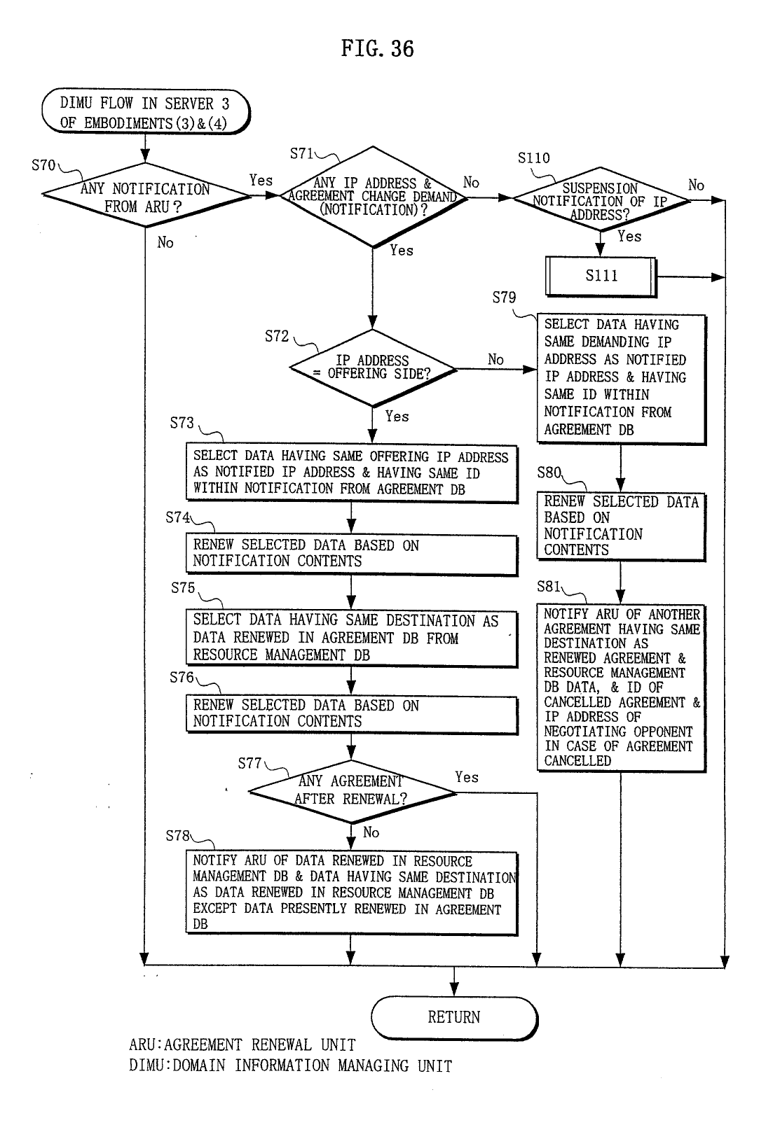

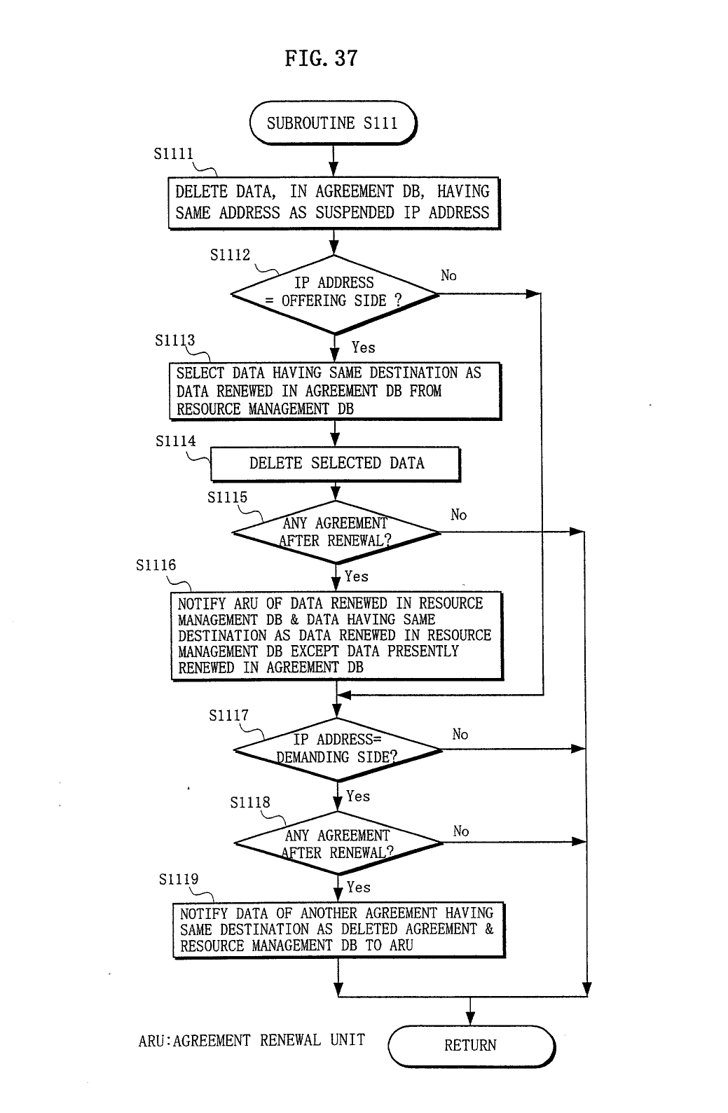

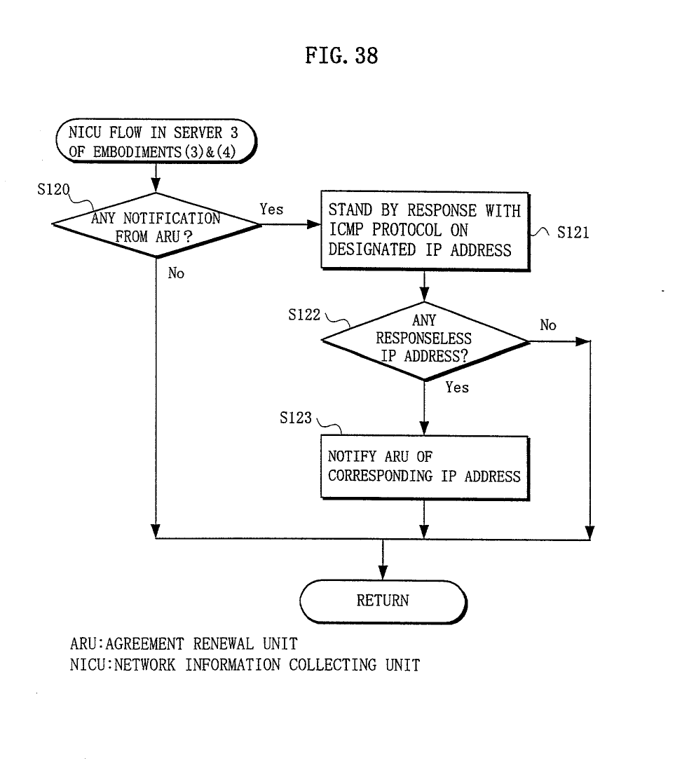

Hereinafter, those operations will be described in sequence referring to FIGS. 6 and 34-38.

(1) The agreement renewal unit 14 of the server 3 notifies the network information collecting unit 16 of the IP address of an in-agreement server in which a contract is being agreed(step S120).

(2) The network information collecting unit 16 collects information from the network information offering units 161 and 162 (network interfaces) of the servers 1 and 2 by using “ping” (ICMP protocol) (steps S121-S122).

(3) It is supposed in this embodiment that a response from the server 2 is received while no response from the server 1 is received, which indicates the fault of the server 1.

(4) The network information collecting unit 16 notifies the agreement renewal unit 14 of the IP address of the server 1 which could not receive the response (step S123).

(5) The agreement renewal unit 14 judges that the server 1 of the IP address notified from the network information collecting unit 16 has been faulted, deletes the IP address of the object server 1 from the in-agreement server management DB 140 as shown in the following table (steps S102, S103), and requests the domain information managing unit 15 of acquiring the data of agreement associated with the deletion of agreement having been made with the server (step S104):

TABLE 28
IN-AGREEMENT SERVER MANAGEMENT DB

IN-AGREEMENT SERVER IP ADDRESS
10.10.30.1

(6) The domain information managing unit 15 deletes the data regarding the notified IP address from the agreement DB 151 and the resource management DB 152 as shown in the following tables (steps S110, S111, S1111-S1414):

TABLE 29
AGREEMENT DB

| | | DEMAND- | BAND | | DESTI- |
|---|---|---|---|---|---|
| | OFFERING | ING | WIDTH | ACCOUNT | NATION |
| ID | IP | IP | (Mbps) | (YEN) | ADDRESS |
| 1 | 10.10.30.1 | 10.10.20.1 | 10 | 1000 | 10.10.30.0 |

TABLE 30
SOURCE MANAGEMENT DB

| | ACCOUNT | |
|---|---|---|
| BANDWIDTH (Mbps) | (YEN) | DESTINATION ADDRESS |
| 10 | 1000 | 10.10.20.0 |
| 10 | 1000 | 10.10.30.0 |

(7) The domain information managing unit 15 notifies the agreement renewal unit 14 of the data (having the same destination net address except the renewed data) associated with the agreement change after the renewal as shown in the following tables (steps S1115-S1119):

TABLE 31
AGREEMENT DB

| | OFFER- | DEMAND- | BAND- | | |
|---|---|---|---|---|---|
| | RING | ING | WIDTH | ACCOUNT | DESTINATION |
| ID | IP | IP | (Mbps) | (YEN) | ADDRESS |
| 1 | 10.10.30.1 | 10.10.20.1 | 10 | 1000 | 10.10.30.0 |

TABLE 32
SOURCE MANAGEMENT DB

| BANDWIDTH | ACCOUNT | DESTINATION |
|---|---|---|
| (Mbps) | (YEN) | ADDRESS |
| 10 | 1000 | 10.10.30.0 |

(8) The agreement renewal unit 14 compares the bandwidths of supply data and demand data to determine an agreement to be changed.

At this time, since the resource management DB 152 has data as shown in tables 31 and 32 while the agreement DB 151 has no data consuming the resource, the change of agreement regarding the resource management DB 152 is checked (steps S101, S1011-S1013). In this embodiment, it is found necessary to change (suspend) the agreement contents of ID 1.

(9) The agreement renewal unit 14 prepares a message of an agreement change demand \mathring{2} (see FIG. 6) with the destination IP address being made “10.10.30.1” as shown in the following table (steps S1015, S1016):

TABLE 33

| | | | |
|---|---|---|---|
| | BANDWIDTH | ACCOUNT | DESTINATION |
| ID | (Mbps) | (YEN) | ADDRESS |

1

(10) The agreement renewal unit 14 notifies the transmitting unit 13 of the prepared message.

(11) The transmitting unit 13 transmits the agreement change demand \mathring{2} to the server 2 of the IP address (10.10.30.1).

(12) The server 2 receives the agreement change demand from the server 3 at the receiving unit 11, the agreement unit 12 prepares an agreement change notification to the server 3, and the transmitting unit 13 transmits the agreement change notification.

(13) The server 2 transmits data of an agreement change notification \mathring{3} (see FIG. 6) to the server 3 as shown in the following table:

TABLE 34

| | | | | |
|---|---|---|---|---|
| | | BANDWIDTH | ACCOUNT | DESTINATION |
| FLAG | ID | (Mbps) | (YEN) | ADDRESS |

| | |
|---|---|
| 5 | 1 |

(14) The server 3 receives the agreement change notification at the receiving unit 11, and acquires the source IP address (10.10.30.1).

(15) The receiving unit 11 transmits the data of the agreement change notification to the agreement renewal unit 14 with the offering IP address being made “10.10.30.1”.

(16) The agreement renewal unit 14 finds it to be an agreement suspension notification because the data are for the agreement change notification (step S94) and have no numerical values in each item (step S95), and as shown in the following table, deletes the IP address of the data source from the in-server management DB 140 (step S99). Also, the agreement renewal unit 14 notifies the domain information managing unit 15 of the information renewal and the information retrieval (step S96):

TABLE 35

IN-AGREEMENT SERVER MANAGEMENT DB
IN-AGREEMENT SERVER IP ADDRESS

(17) The domain information managing unit 15 renews the agreement DB and the resource management DB based on their ID's (steps S73, S74).

(18) The domain information managing unit 15 renews the DB's 151 and 152 based on the notified data as shown in the following tables, where no notification is provided to the agreement renewal unit 14 because no agreement contents exist:

TABLE 36
AGREEMENT DB

| | | | | | |
|---|---|---|---|---|---|
| | OFFER- | DEMAND- | BAND- | | |
| | ING | ING | WIDTH | ACCOUNT | DESTINATION |
| ID | IP | IP | (Mbps) | (YEN) | ADDRESS |

TABLE 37
SOURCE MANAGEMENT DB

| BANDWIDTH | ACCOUNT | DESTINATION |
|---|---|---|
| (Mbps) | (YEN) | ADDRESS |
| 10 | 1000 | 10.10.20.0 |

Thus, it is made possible for the server 3 to change the agreement with the server 2 based on the change regarding the agreement with the server 1 due to network states.

Embodiment (4) Which Corresponds to the Schematic Operation Sequence (2) of the Present Invention [2]

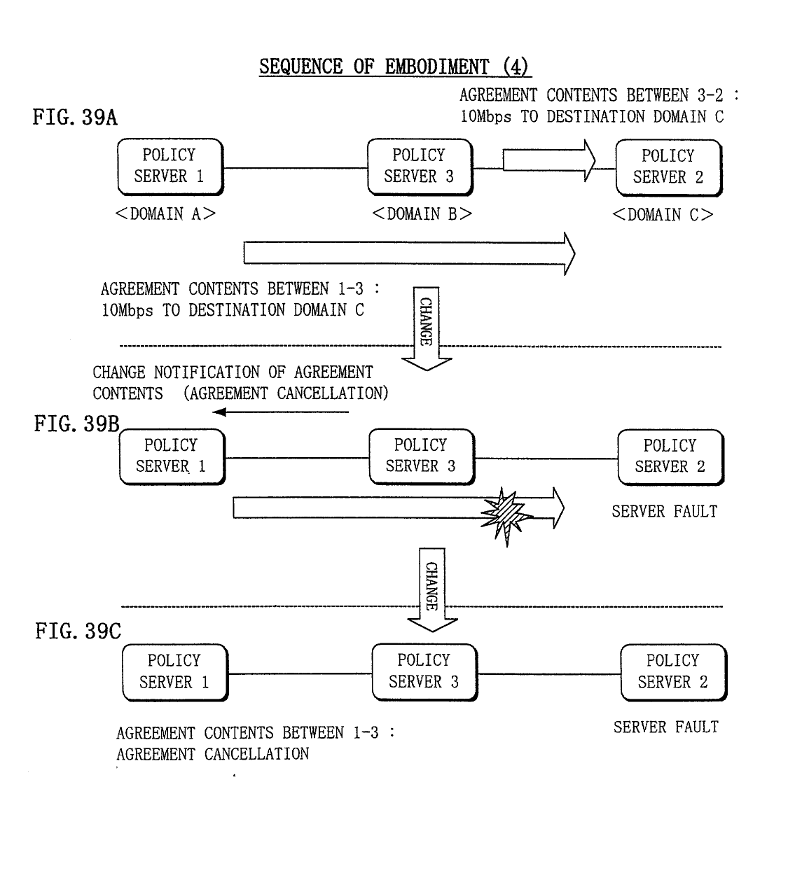

FIG. 39 schematically shows an embodiment (4) of the present invention, which particularly corresponds to the schematic operation sequence (2) of the present invention [2] shown in FIG. 7.

Namely, the above embodiment (3) has dealt with the case where the server 1 on the agreement demanding side is faulted due to network variations while this embodiment (4) deals with the case where the server 2 on the agreement offering side is faulted (see FIG. 39B). As a result, as shown in FIG. 39C, it is made possible to automatically renew the agreement depending on the change of network state.

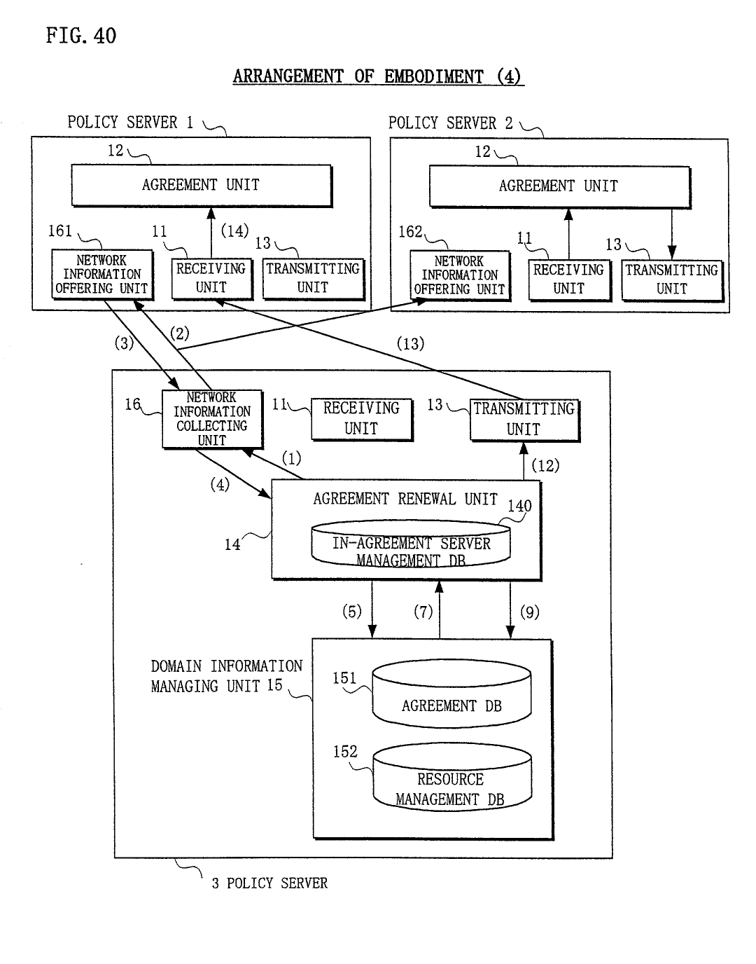

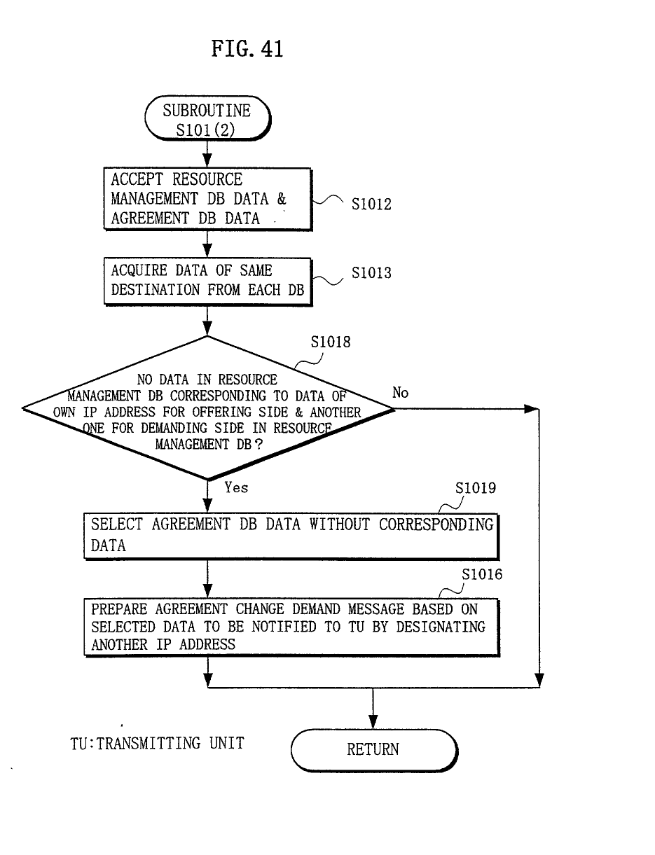

FIG. 40 shows arrangements of the servers 1-3 for realizing the embodiment (4), which is similar to the arrangement of the embodiment (3) shown in FIG. 33 except the operations as shown by the reference numerals. Hereinafter, these operations will be described referring to FIGS. 7 and 41.

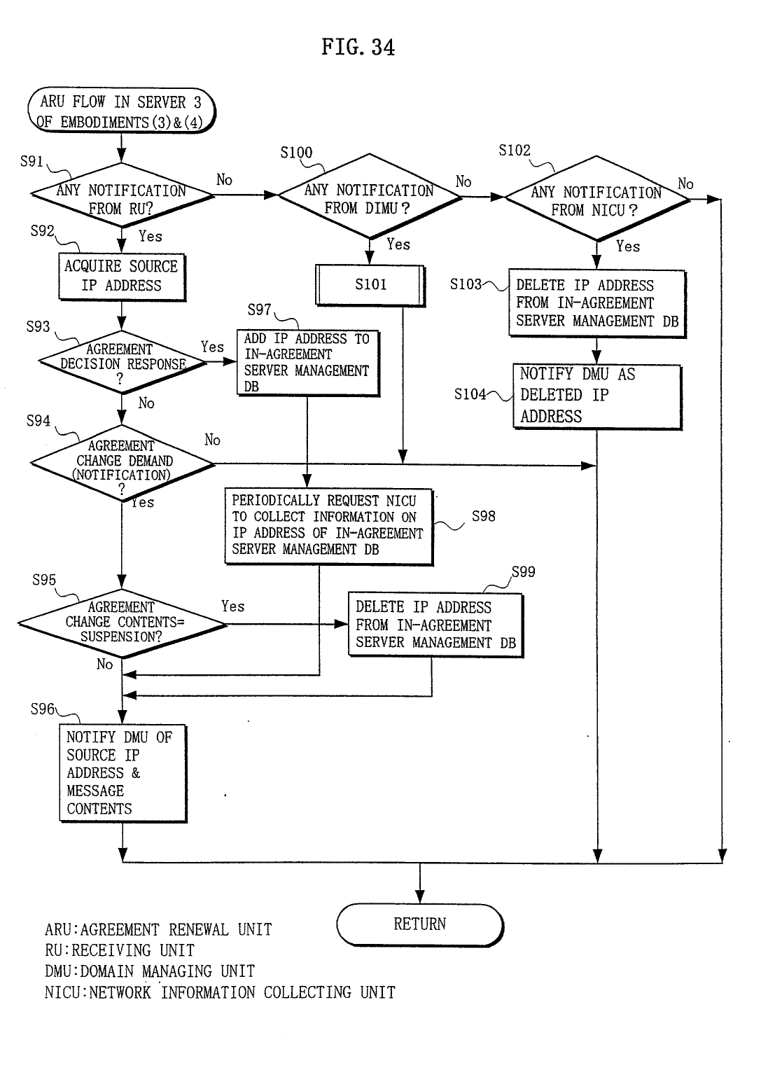

It is to be noted that the above noted tables 1-5 are similarly applied to this embodiment (4). Moreover, the flow charts shown in FIGS. 33-38 are similarly applied to a subroutine S101 (see FIG. 34) shown in FIG. 41 except “change notification” being read for “change demand”.

It is supposed that the agreement renewal unit 14 of the server 3 preliminarily holds the IP address of the opponent having received or transmitted the agreement decision response shown in the above table 27 in the in-agreement server management DB 140.

(1) The agreement renewal unit 14 notifies the network information collecting unit 16 of the IP address of an in-agreement server (step S120).

(2) The network information collecting unit 16 collects information from the network information offering units 161 and 162 (network interfaces) of the servers by using “ping” (ICMP protocol) (steps S121-S122).

(3) It is supposed in this embodiment that the server 1 receives a response while the server 2 receives no response, which indicates that server 2 is faulted.

(4) The network information collecting unit 16 notifies the agreement renewal unit 14 of the IP address of the server 2 which could not receive the response (step S123).

(5) Judging that the server 2 of the IP address notified from the network information collecting unit 16 has been faulted, the agreement renewal unit 14 deletes the IP address of the object server 2 from the in-agreement server management DB 140 as shown in the following table (steps S102, S103), and requests the domain information managing unit 15 to acquire the data of agreement associated with the deletion of the agreement having been made with the server (step S104).

TABLE 38
IN-AGREEMENT SERVER MANAGEMENT DB
IN-AGREEMENT SERVER IP ADDRESS
10.10.10.1

(6) The domain information managing unit 15 deletes the data regarding the notified IP address from the agreement DB 151 and the resource management DB 152 as shown in the following tables (steps S110, S111, S1111-S1114):

TABLE 39
AGREEMENT DB

| | OFFER- | DEMAND- | BAND- | | |
|---|---|---|---|---|---|
| ID | ING | ING | WIDTH | ACCOUNT | DESTINATION |
| ID | IP | IP | (Mbps) | (YEN) | ADDRESS |
| 2 | 10.10.20.1 | 10.10.10.1 | 10 | 2000 | 10.10.30.0 |

TABLE 40
SOURCE MANAGEMENT DB

| BANDWIDTH | ACCOUNT | DESTINATION |
|---|---|---|
| (Mbps) | (YEN) | ADDRESS |
| 10 | 1000 | 10.10.20.0 |

(7) The domain information managing unit 15 notifies the agreement renewal unit 14 of the data, having the same destination net address except the renewed data, associated with the agreement change after the renewal as shown in the following tables (steps S1115-S1119):

TABLE 42
AGREEMENT DATA

| | OFFERING | DEMANDING | BANDWIDTH | ACCOUNT | DESTINATION |
|---|---|---|---|---|---|
| ID | IP | IP | (Mbps) | (YEN) | ADDRESS |
| 2 | 10.10.20.1 | 10.10.10.1 | 10 | 2000 | 10.10.30.0 |

TABLE 42
SOURCE MANAGEMENT DATA

| | | |
|---|---|---|
| BANDWIDTH | ACCOUNT | DESTINATION |
| (Mbps) | (YEN) | ADDRESS |

(8) The agreement renewal unit 14 compares the bandwidths of supply data and demand data to determine an agreement to be changed.

At this time, since the data resource management DB 152 has no data while the agreement DB 151 has data consuming the resource, the agreement renewal unit 14 checks the change of the agreement DB 151 (steps S1012, S1013, S1018). It is found necessary in this embodiment to change (suspend) the agreement contents of ID=2.

(9) The agreement renewal unit 14 transmits a data renewal notification to the domain information managing unit 15 with the demanding IP address being made “10.10.10.1” as shown in the following table:

TABLE 43
NOTIFICATION DATA

| | BANDWIDTH | ACCOUNT | DESTINATION |
|---|---|---|---|
| ID | (Mbps) | (YEN) | ADDRESS |
| 2 | | | |

(10) The domain information managing unit 15 renews the agreement DB 151 based on the notified data as shown in the following table (steps S71-S74):

TABLE 44
AGREEMENT DB

| | | | | | |
|---|---|---|---|---|---|
| ID | OFFERING | DEMANDING | BANDWIDTH | ACCOUNT | DESTINATION |
| | IP | IP | (Mbps) | (YEN) | ADDRESS |

(11) The agreement renewal unit 14 prepares an agreement change notification message with the destination IP address being made “10.10.10.1” (steps S1019, S1016).

TABLE 45

| | | | | |
|---|---|---|---|---|
| | | BANDWIDTH | ACCOUNT | DESTINATION |
| FLAG | ID | (Mbps) | (YEN) | ADDRESS |

| | |
|---|---|
| 5 | 2 |

(12) The agreement renewal unit 14 deletes the IP address “10.10.10.1” from the in-agreement server management DB 140, and notifies the transmitting unit 13 of the prepared message as shown in the following table (step S99):

TABLE 46

IN-AGREEMENT SERVER MANAGEMENT DB
IN-AGREEMENT SERVER IP ADDRESS

(13) The transmitting unit 13 transmits an agreement change notification to the IP address “10.10.10.1”.

(14) The server 1 having received the agreement change notification message confirms the change of the agreement contents, and deletes the agreement contents made with the servers 3 as shown in the following table:

TABLE 47
AGREEMENT CONTENTS OF SERVER 1

| | | | | | |
|---|---|---|---|---|---|
| ID | OFFERING | DEMANDING | BANDWIDTH | ACCOUNT | DESTINATION |
| | IP | IP | (Mbps) | (YEN) | ADDRESS |

Thus, it is made possible for the server 3 to change the agreement with server 1 based on the change regarding the agreement with the server 2 due to a network state change.

Embodiment (5) Which Corresponds to the Schematic Arrangement (1) of the Present Invention [3]

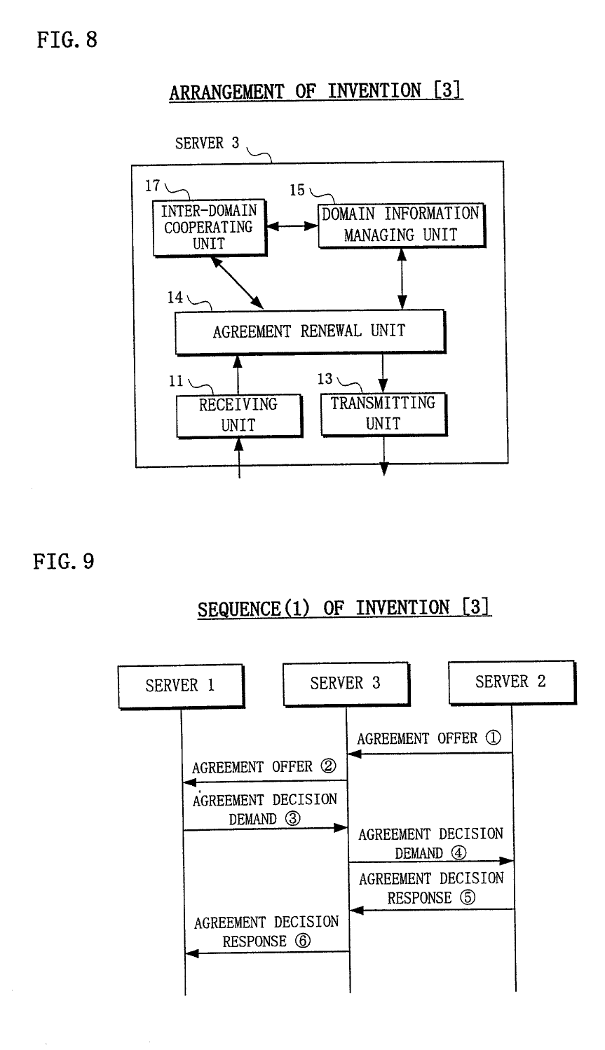

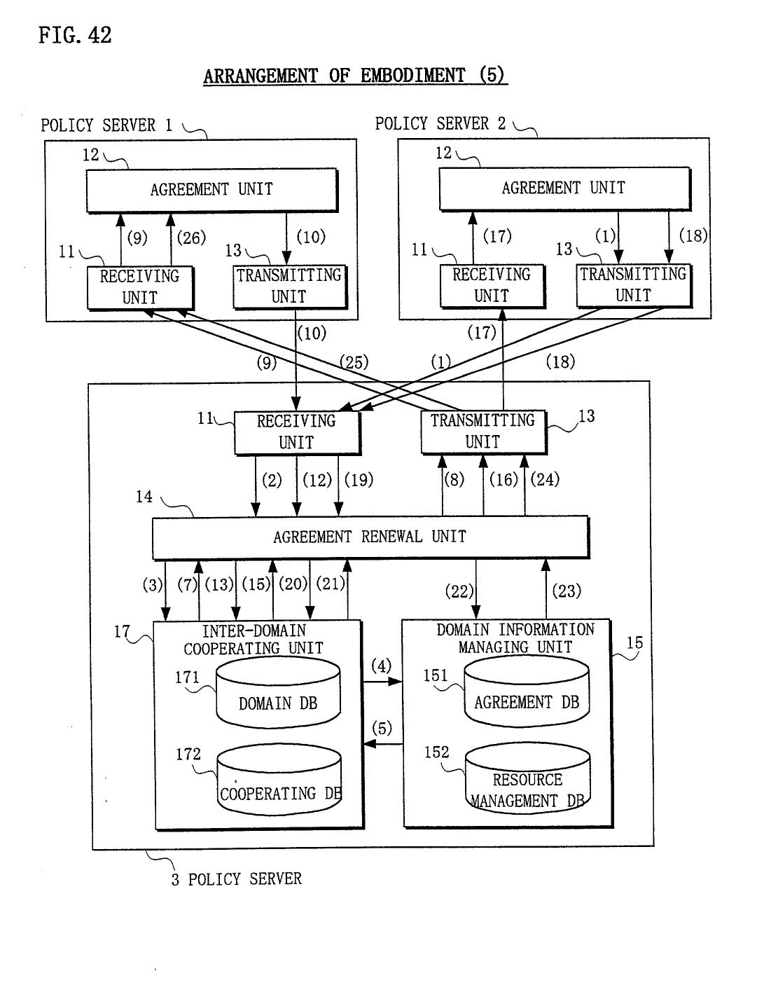

FIG. 42 shows an embodiment (5) of the present invention, which particularly shows an arrangement of the present invention shown in FIG. 8 and whose operation corresponds to the schematic operation sequence (1) shown in FIG. 9.

Namely, the inter-domain cooperating unit 17 of the server 3 in the arrangement shown in FIG. 8 includes a domain DB 171 and a cooperating DB 172, thereby confirming a demand of another agreement/other agreements for an automatic new agreement, resulting in an automatic agreement regarding a service across domains.

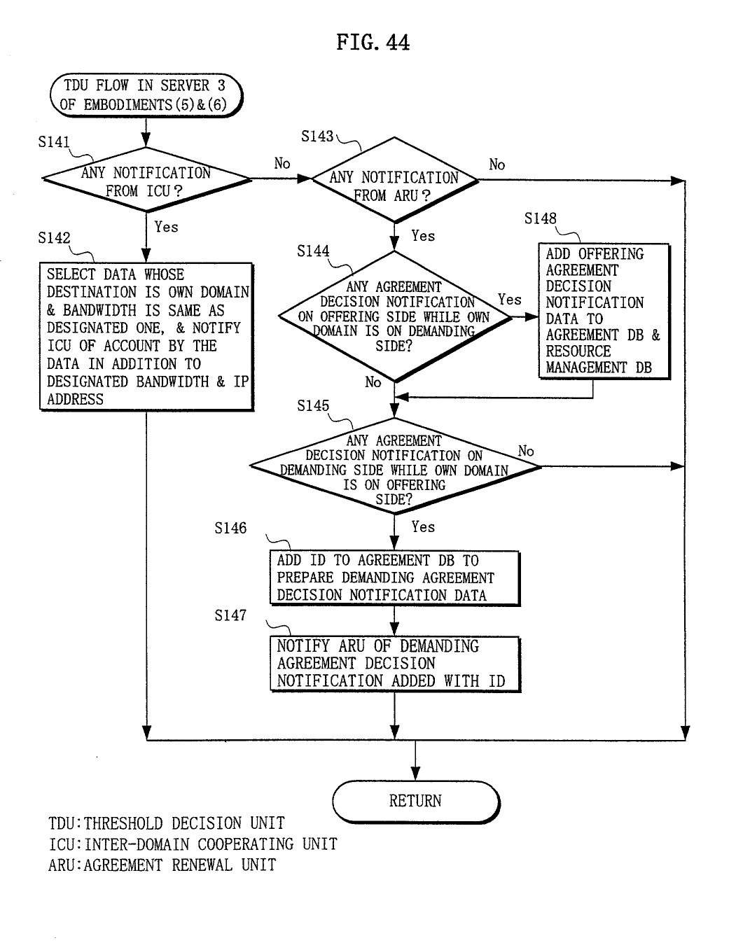

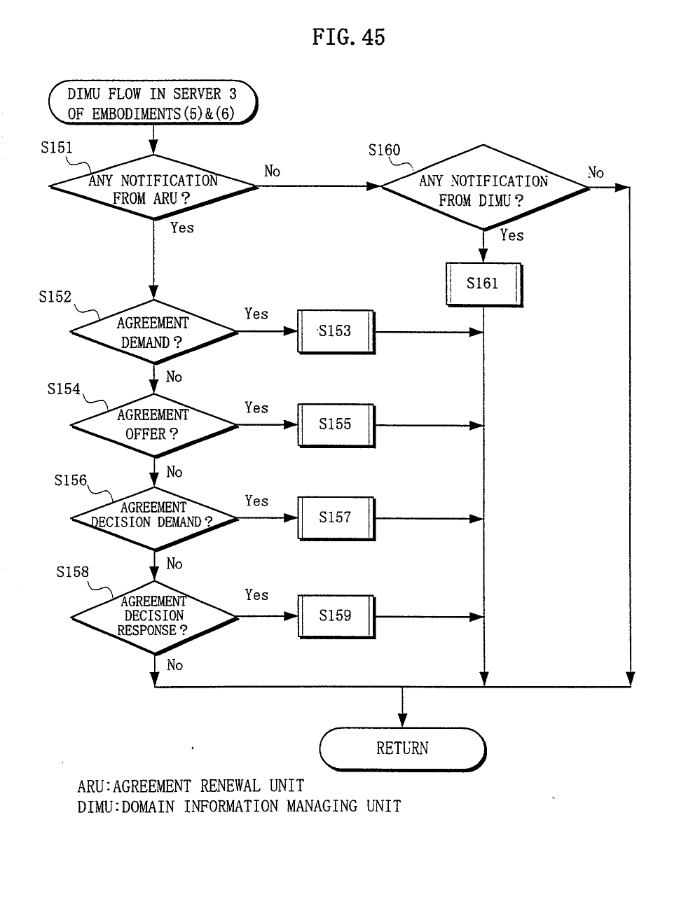

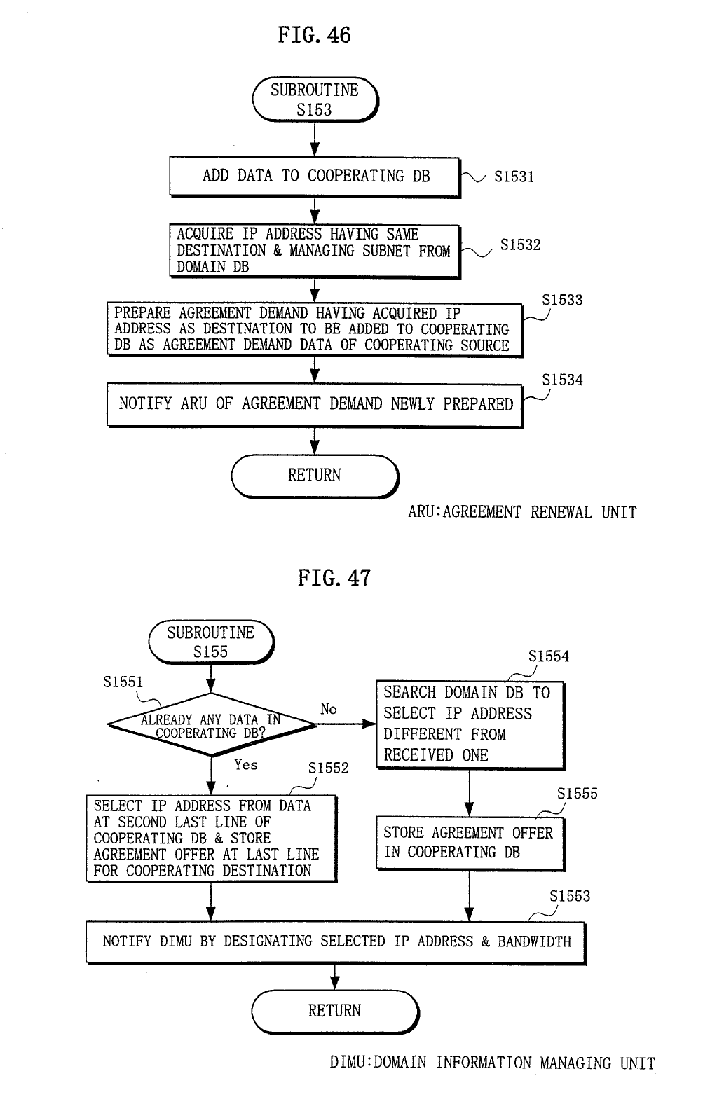

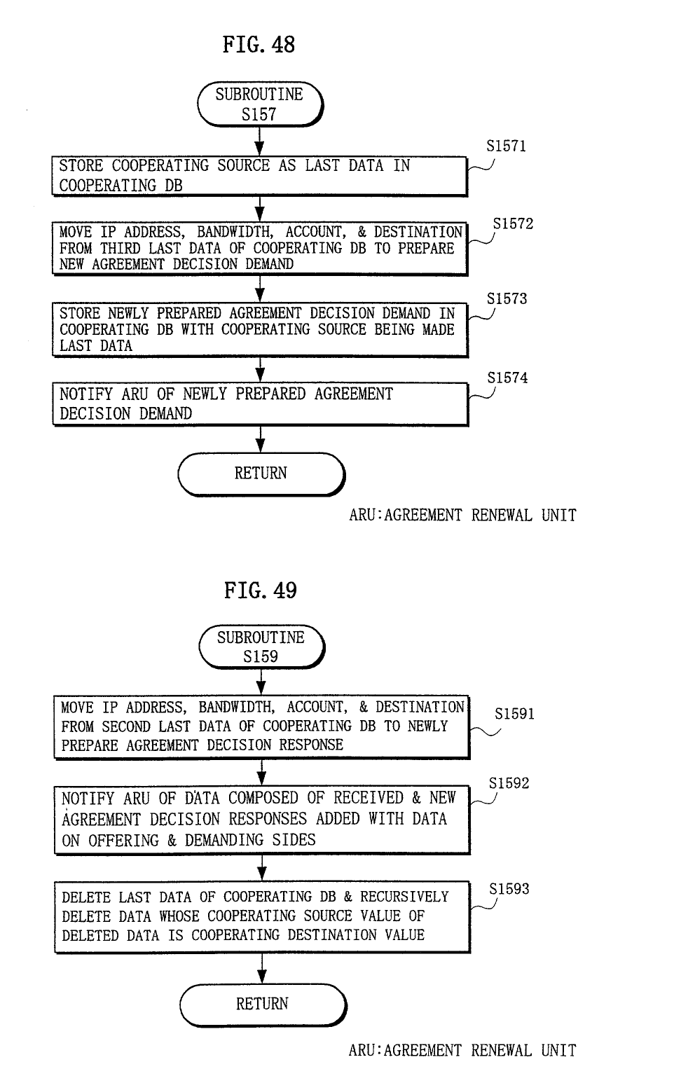

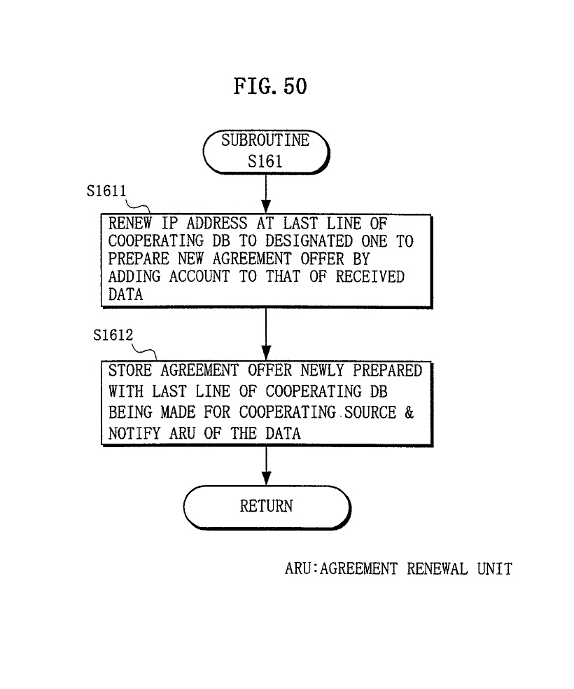

Hereinafter, the operations thereof will be described referring to FIGS. 9 and 43-50), in which the above table 1 is similarly applied to this embodiment (5).

At first, it is supposed that the server 3 preliminarily holds the IP address of a communicable server and subnet information managed by the server in the domain DB 171 in the inter-domain cooperating unit 17 as shown in the following table:

TABLE 48
DOMAIN DB

| IP ADDRESS | MANAGING SUBNET |
|---|---|
| 10.10.10.1 | 10.10.10.0 |
| 10.10.30.1 | 10.10.30.0 |

It is also supposed that the server 3 holds data in the resource management DB 152 of its own domain B as shown in the following table:

TABLE 49
SOURCE MANAGEMENT DB OF SERVER 3

| | | DESTINATION |
|---|---|---|
| BANDWIDTH (Mbps) | ACCOUNT (YEN) | ADDRESS |
| 5 | 1000 | 10.10.20.0 |

(1) The server 2 on the agreement offering side transmits data of an agreement offer \mathring{1} (see FIG. 9) to the server 3 as shown in the following table:

TABLE 50

| | | BANDWIDTH | ACCOUNT | DESTINATION |
|---|---|---|---|---|
| FLAG | ID | (Mbps) | (YEN) | ADDRESS |
| 3 | | 5 | 1000 | 10.10.30.0 |

(2) The agreement renewal unit 14 of the server 3 receives the data at the receiving unit 11 (step S131).

(3) The agreement renewal unit 14 notifies the inter-domain cooperating unit 17 of the IP address of the source server 2 and the received data, (steps S132, S133). The inter-domain cooperating unit 17 stores the received IP address and data in the cooperating DB 172 as shown in the following table (steps S151, S154, S155, S1551, S1552), where a cooperating source and a cooperating destination are provided with ID's, and “IP address” is provided with an IP address of communication opponent:

TABLE 51

| | COOPERA- | | | | | | |
|---|---|---|---|---|---|---|---|
| COOPERA- | TING | | | | BAND- | | DESTI- |
| TING | DESTINA- | | | | WIDTH | ACCOUNT | NATION |
| SOURCE | TION | IP | FLAG | ID | (Mbps) | (YEN) | ADDRESS |
| | | 10.10.30.1 | 3 | | 5 | 1000 | 10.10.30.0 |

(4) The inter-domain cooperating unit 17 retrieves the domain DB 171 to select an IP address different from the received IP address (steps S1554, S1555).

In this embodiment, the IP address “10.10.10.1” of the server 1 is supposed to be selected. In case where another IP address is selected, a passing account investigation request of its own domain B is notified to the domain information managing unit 15 by designating the bandwidth and IP address (step S1553).

(5) The domain information managing unit 15 selects data consistent with the received bandwidth, destination, and its own IP address, (10.10.20.1) from the resource management DB 152. Then, the data of the bandwidth, account, and designated IP address contained in the selected data are notified to the inter-domain cooperating unit 17 as shown in the following table (steps S141, S142):

TABLE 52

| | | DESTINATION |
|---|---|---|
| BANDWIDTH (Mbps) | ACCOUNT (YEN) | ADDRESS |
| 5 | 1000 | 10.10.20.0 |

(6) The inter-domain cooperating unit 17 in response to the notification increments the account on the received data, and prepares data of an agreement offer \mathring{2} (see FIG. 9) for the IP address (10.10.10.1) of the server 1 (steps S160, S161, S1611). In this case, a flag, bandwidth, and destination are moved from the cooperating source data. Regarding the account, the value of the cooperating source is added with the account within the resource management DB 152. Also, the IP address item is stored with that of the cooperating destination, the cooperating destination item of the cooperating source data is stored with a value, and the same values are stored in the cooperating source item of data newly prepared. Then, the prepared data (see the following table) are stored in the cooperating DB 172, in which the items of the cooperating source and cooperating destination are stored with the respective values (step S1612).

Namely, the cooperating source and the cooperating destination have a mutual relationship of parent and child as shown in the following table. When the parent of IP address “10.10.30.1” is sought, a pointer “1” is stored in the cooperating source at a line of the data so that by seeking the cooperating destination having been stored with the pointer “1”, the data of another IP address “10.10.30.1” which has already been stored are found to be the parent. This means that between two servers a cooperating relationship has been prescribed.

TABLE 53

| | COOPERA- | | | | | | |
|---|---|---|---|---|---|---|---|
| COOPERA- | TING | | | | BAND- | | |
| TING | DESTINA- | | | | WIDTH | ACCOUNT | DESTINATION |
| SOURCE | TION | IP | FLAG | ID | (Mbps) | (YEN) | ADDRESS |
| | 1-PARENT | 10.10.30.1 | 3 | | 5 | 1000 | 10.10.30.0 |
| 1-CHILD | | 10.10.10.1 | 3 | | 5 | 2000 | 10.10.30.0 |

(7) The inter-domain cooperating unit 17 notifies the agreement renewal unit 14 of the newly prepared data by designating the IP address (10.10.10.1) of the server 1 (step S1612).

TABLE 54

| | | BANDWIDTH | ACCOUNT | DESTINATION |
|---|---|---|---|---|
| FLAG | ID | (Mbps) | (YEN) | ADDRESS |
| 3 | | 5 | 2000 | 10.10.30.0 |

(8) The agreement renewal unit 14 notifies the transmitting unit 13 of the received data as the message of the agreement offer \mathring{2} by designating the IP address (10.10.10.1) without notification (steps S134, S135, S137).

(9) The transmitting unit 13 transmits the message of the agreement offer \mathring{2} to the server 1 of the IP address (10.10.10.1).

(10) The server 1 receives at the receiving unit 11 the message of the agreement offer \mathring{2}, prepares an agreement decision demand \mathring{3} (see FIG. 9) at the agreement unit 12 as shown in the following table, and transmits the agreement decision demand \mathring{3} to the server 3 from the transmitting unit 13:

TABLE 55

| | | BANDWIDTH | ACCOUNT | DESTINATION |
|---|---|---|---|---|
| FLAG | ID | (Mbps) | (YEN) | ADDRESS |
| 1 | | 5 | 2000 | 10.10.30.0 |

(11) The server 3 receives the agreement decision demand \mathring{3} from the server 1 at the receiving unit 11.

(12) The agreement renewal unit 14 of the server 3 acquires a destination IP address and received data from the receiving unit 11.

(13) The agreement renewal unit 14 notifies the inter-domain cooperating unit 17 of the IP address and the received data (steps S131-S133).

(14) The inter-domain cooperating unit 17 retrieves the cooperating DB 172 to newly prepare an agreement decision demand \mathring{4} (see FIG. 9) by referring to the last data prior to the current ones. Namely, supposing that the data stored at that time at the last line are for “parent” and the current new data are for the server itself, data are stored attached with the same pointer at the next line with the server itself being made “child”. From the data before the cooperating DB 172 by three (assuming the line shown by a mark ⊚ is the last line in the following table, the data are the third counted from the last line being made “1” as shown by a mark ☆ in the following table; this shows the data of agreement offer \mathring{1} from the transmitting source server 2), the agreement decision demand \mathring{4} shown by a new mark ¤ (having the same pointer as the agreement decision demand \mathring{3} to form a parent and child relationship) is prepared. In this case, the IP address as well as the bandwidth, account, and destination are moved. Also, the flag is referred to the received data.

Then, the data currently received and prepared are respectively stored in the cooperating source and the cooperating destination items with the corresponding values, to be added to the cooperating DB 172 as shown in the following table (steps S151, S156, S157, S1571-S1573):

TABLE 56
COOPERATING DB

| | | COOPERA- | | | | | | |
|---|---|---|---|---|---|---|---|---|
| | COOPERA- | TING | | | | BAND- | | DESTINA- |
| | TING | DESTINA- | | | | WIDTH | ACCOUNT | TION |
| | SOURCE | TION | IP | FLAG | ID | (Mbps) | (YEN) | ADDRESS |
| ☆ | | 1-PARENT | 10.10.30.1 | 3 | | 5 | 1000 | 10.10.30.0 |
| | 1-CHILD | 2-PARENT | 10.10.10.1 | 3 | | 5 | 2000 | 10.10.30.0 |
| ⊚ | 2-CHILD | 3-PARENT | 10.10.10.1 | 1 | | 5 | 2000 | 10.10.30.0 |
| □ | 3-CHILD | | 10.10.30.1 | 1 | | 5 | 1000 | 10.10.30.0 |

The above table shows that from the top in sequence the agreement offer \mathring{1} is transmitted from the server 2 to the server 3, a new agreement offer \mathring{2} is transmitted from the server 3 to the server 1, the agreement decision demand \mathring{3} is transmitted from the server 1 to the server 3, and a new agreement decision demand \mathring{4} is transmitted from the server 3 to the server 2.

(15) The inter-domain cooperating unit 17 notifies the agreement renewal unit 14 of the data newly prepared as shown in the following table by designating the IP address (10.10.10.1):

TABLE 57

| | | BANDWIDTH | ACCOUNT | DESTINATION |
|---|---|---|---|---|
| FLAG | ID | (Mbps) | (YEN) | ADDRESS |
| 1 | | 5 | 1000 | 10.10.30.0 |

(16) The agreement renewal unit 14 designates the IP address (10.10.30.1) to the transmitting unit 13 for notifying the received data as a message of the agreement decision demand \mathring{4}.

(17) The transmitting unit 13 transmits the message of the agreement decision demand \mathring{4} to the server 2.

(18) The server 2 receives the message of the agreement decision demand \mathring{4} at the receiving unit 11, prepares an agreement decision response \mathring{5} (see FIG. 9) at the agreement unit, and transmits the agreement decision response \mathring{5} to the server 3 from the transmitting unit 13 as shown in the following table, at which the server 2 is deemed to have an agreement with the server 3:

TABLE 58

| | | BANDWIDTH | ACCOUNT | DESTINATION |
|---|---|---|---|---|
| FLAG | ID | (Mbps) | (YEN) | ADDRESS |
| 4 | 1 | 5 | 1000 | 10.10.30.0 |

(19) The agreement renewal unit 14 receives the data from the receiving unit 11.

(20) The agreement renewal unit 14 notifies the inter-domain cooperating unit 17 of the IP address of the transmitting source and the received data (steps S131-S133).

(21) The inter-domain cooperating unit 17 retrieves the cooperating DB 172, refers to the data at second last line by one line, and prepares a new agreement decision demand (steps S158, S159, S1591). In this case, the IP address as well as the bandwidth, account, and destination are moved. Also, the flag is referred to the received data. Furthermore, the data currently received and prepared as shown in the following tables, attached with flags distinguishable for the new and old ones, are respectively notified to the agreement renewal unit 14 by designating the destination (step S1592).

Namely, the data are notified to the agreement renewal unit 14 for the purposes of managing, as an established agreement, both of the received agreement decision response and the newly prepared agreement decision response. Because of the agreement established, the cooperating source and cooperating destination items are searched in the cooperating DB 172 with their pointers to delete the associated data (step S1593).

TABLE 59
COOPERATING DB

| | | | | | | | |
|---|---|---|---|---|---|---|---|
| | COOPERA- | | | | | | |
| COOPERA- | TING | | | | BAND- | | DESTI- |
| TING | DESTINA- | | | | WIDTH | ACCOUNT | NATION |
| SOURCE | TION | IP | FLAG | ID | (Mbps) | (YEN) | ADDRESS |

TABLE 60
AGREEMENT DECISION RESPONSE DATA

| | | | | BAND- | | DESTI- |
|---|---|---|---|---|---|---|
| OFFERING | DEMAND- | | | WIDTH | ACCOUNT | NATION |
| IP | ING IP | FLAG | ID | (Mbps) | (YEN) | ADDRESS |
| 10.10.30.1 | 10.10.20.1 | 4 | 1 | 5 | 1000 | 10.10.30.0 |
| 10.10.20.1 | 10.10.10.1 | 4 | | 5 | 2000 | 10.10.30.0 |

(22) The agreement renewal unit 14 having received the agreement decision response from the inter-domain cooperating unit 17 notifies the domain information managing unit 15 of the designated IP address together with the data on the agreement offering side and the agreement demanding side respectively added to the agreement decision response (steps S131, S134-S136).

(23) The domain information managing unit 15 renews the agreement DB 151 and the resource management DB 152 based on the received data. Also, new data added with ID attached at that time as well as destination IP address are notified to the agreement renewal unit 14 as shown in the following tables (steps S141, S143-S147):

TABLE 61
AGREEMENT DB

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 1 | 10.10.30.1 | 10.10.20.1 | 5 | 1000 | 10.10.30.0 |
| 2 | 10.10.20.1 | 10.10.10.1 | 5 | 2000 | 10.10.30.0 |

TABLE 62
SOURCE MANAGEMENT DB

| | | DESTINATION |
|---|---|---|
| BANDWIDTH (Mbps) | ACCOUNT (YEN) | ADDRESS |
| 5 | 1000 | 10.10.20.0 |
| 5 | 1000 | 10.10.30.0 |

(24) The agreement renewal unit 14 prepares an agreement decision response \mathring{6} (see FIG. 9) based on the received data to be transmitted to the transmitting unit 13 (steps S131, S134, S138, S139).

TABLE 63

| | | BANDWIDTH | ACCOUNT | DESTINATION |
|---|---|---|---|---|
| FLAG | ID | (Mbps) | (YEN) | ADDRESS |
| 4 | 2 | 5 | 1000 | 10.10.30.0 |

(25) The transmitting unit 13 transmits the message of the agreement decision response \mathring{6} to the server 1 of the IP address (10.10.10.1).

(26) The server 1 receives the message of the agreement decision response \mathring{6} at the receiving unit 11 whereby the agreement unit 12 recognizes the agreement between he servers 1 and 3.

Thus, by confirming a demand of agreement with other domains based on the agreement contents upon making the agreement, the server 3 enables an automatic agreement regarding a service across domains.

Embodiment (6) Which Corresponds to the Schematic Arrangement of the Present Invention [3]

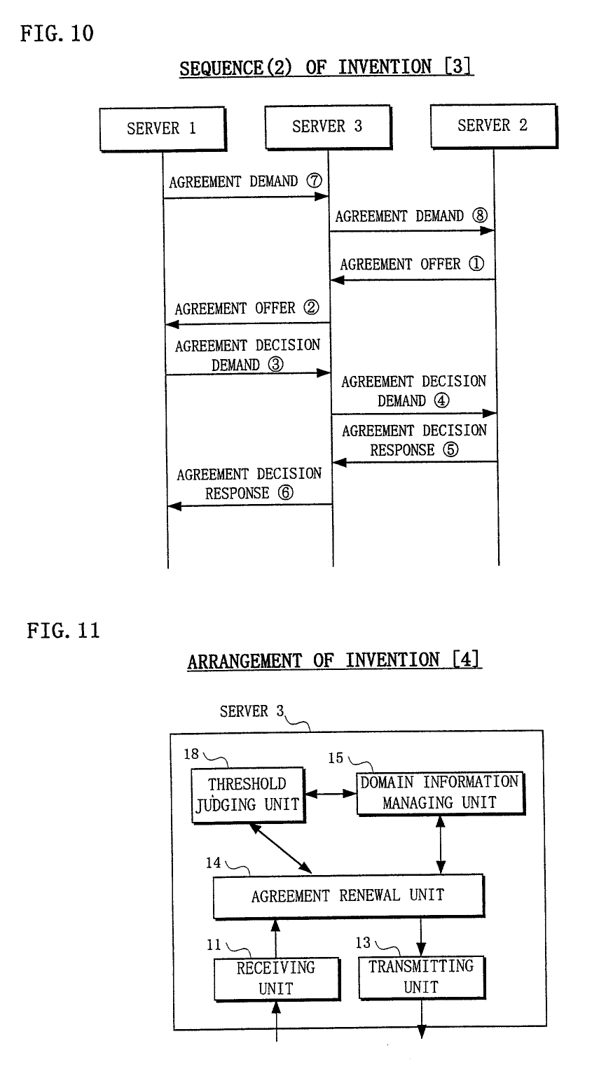

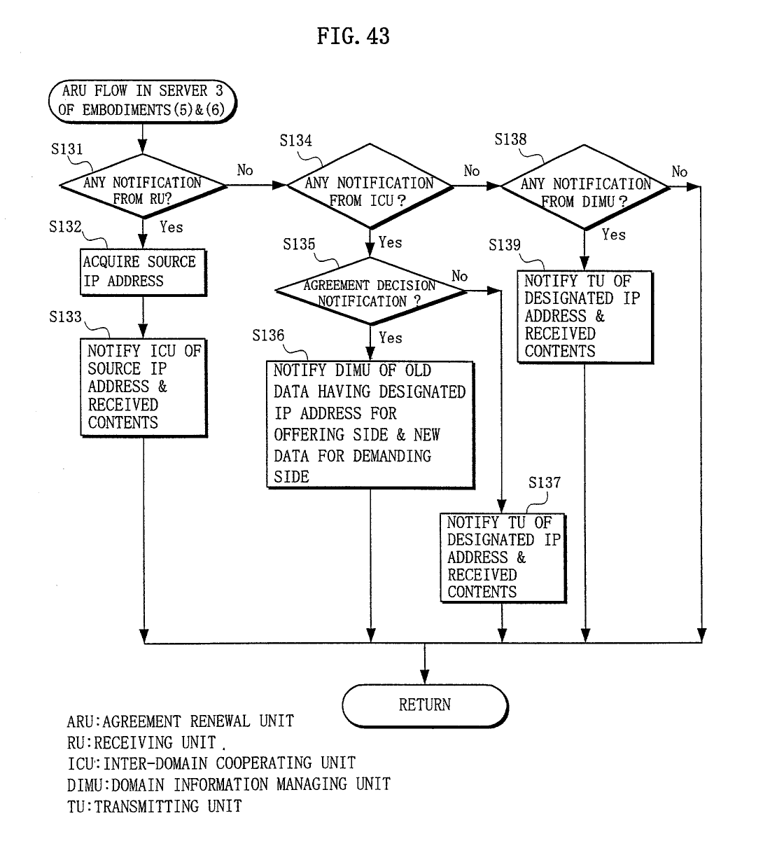

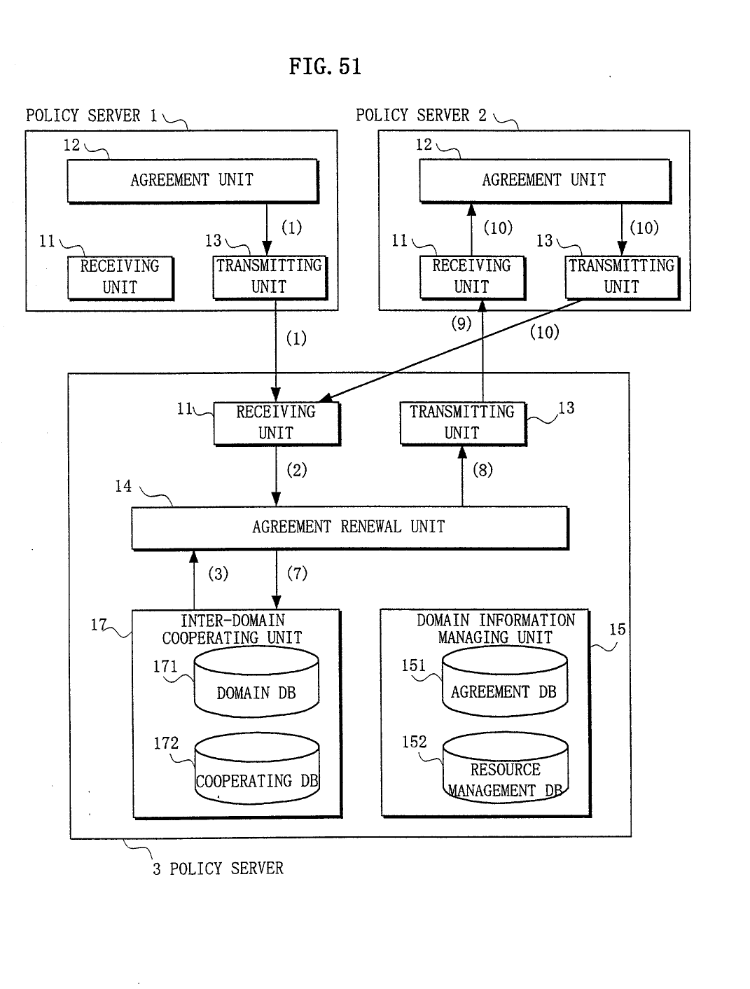

FIG. 51 shows an embodiment (6) of the present invention, the arrangement of which is similar to that in FIG. 42 but the operation of which is different therefrom, which will be described in the following. It is be noted that this operation corresponds to that in FIG. 10 so that the flow charts of FIGS. 43-50 are applied here without any modification, and also the above tables 1, 48, and 49 are similarly applied.

(1) The server 1 transmits data of an agreement demand \mathring{7} to the server 3 as shown in the following table:

TABLE 64

| | | BANDWIDTH | ACCOUNT | DESTINATION |
|---|---|---|---|---|
| FLAG | ID | (Mbps) | (YEN) | ADDRESS |
| 0 | | 5 | | 10.10.30.0 |

(2) The agreement renewal unit 14 receives data from the receiving unit 11.

(3) The agreement renewal unit 14 notifies the inter-domain cooperating unit 17 of the IP address of the transmitting source and received data (steps S131-S133).

(4) The inter-domain cooperating unit 17 stores the received IP address and data as shown in the following table in the cooperating DB 172 (steps S151-S153, S1531):

TABLE 65

| COOPERATING | COOPERATING | | | | BANDWIDTH | ACCOUNT | DESTINATION |
|---|---|---|---|---|---|---|---|
| SOURCE | DESTINATION | IP | FLAG | ID | (Mbps) | (YEN) | ADDRESS |
| | | 10.10.10.1 | 0 | | 5 | | 10.10.30.0 |

(5) The inter-domain cooperating unit 17 retrieves the cooperating DB 172 to select an IP address from the data in which the destination of the agreement demand \mathring{7} is equal to the value of the managing subnet item of the cooperating DB 172 (step S1532). In this embodiment, IP address “10.10.30.1” is selected.

(6) Based on the data of the agreement demand \mathring{7} of the cooperating source, the data of the agreement demand \mathring{7} for the IP address (10.10.30.1) are prepared. Namely, the flag, bandwidth, and destination are moved from the data of cooperating source. The IP address is stored with the selected one, the cooperating destination item of the cooperating source data is finally filled with a value, and the same value as the filled value is stored in the cooperating source item of the newly prepared data. Also, the prepared data are stored in the cooperating DB 172 by respectively storing values in the cooperating source and cooperating destination items as shown in the following table (step S1533):

TABLE 66

| COOPERATING | COOPERATING | | | | BANDWIDTH | ACCOUNT | DESTINATION |
|---|---|---|---|---|---|---|---|
| SOURCE | DESTINATION | IP | FLAG | ID | (Mbps) | (YEN) | ADDRESS |
| | 1 | 10.10.10.1 | 0 | | 5 | | 10.10.30.0 |
| 1 | | 10.10.30.1 | 0 | | 5 | | 10.10.30.0 |

(7) The inter-domain cooperating unit 17 notifies the agreement renewal unit 14 of the newly prepared data by designating the IP address (10.10.30.1) (step S1534).

TABLE 67

| | | BANDWIDTH | ACCOUNT | DESTINATION |
|---|---|---|---|---|
| FLAG | ID | (Mbps) | (YEN) | ADDRESS |
| 0 | | 5 | | 10.10.30.0 |

(8) The agreement renewal unit 14 notifies the transmitting unit 13 of the received data as a message of an agreement demand \mathring{8} by designating the IP address (10.10.30.1) (steps S131, S134, S135, S137).

(9) The transmitting unit 13 transmits the message of the agreement demand \mathring{8} to the server 2 of the IP address (10.10.30.1).

(10) The server 2 receives the message of the agreement demand \mathring{8} from the receiving unit 11, prepares the message of the corresponding agreement offer \mathring{1} at the agreement unit 12, and transmits the message of the agreement offer \mathring{1} from the transmitting unit 13.

The following sequence is the same as the one after the agreement offer \mathring{1} in the above embodiment (5).

Thus, by confirming a demand of agreement with other domains based on the agreement contents upon making the agreement, the server 3 enables an automatic agreement regarding a service across domains.

Embodiment (7) Which Correspond to the Present Invention [4]

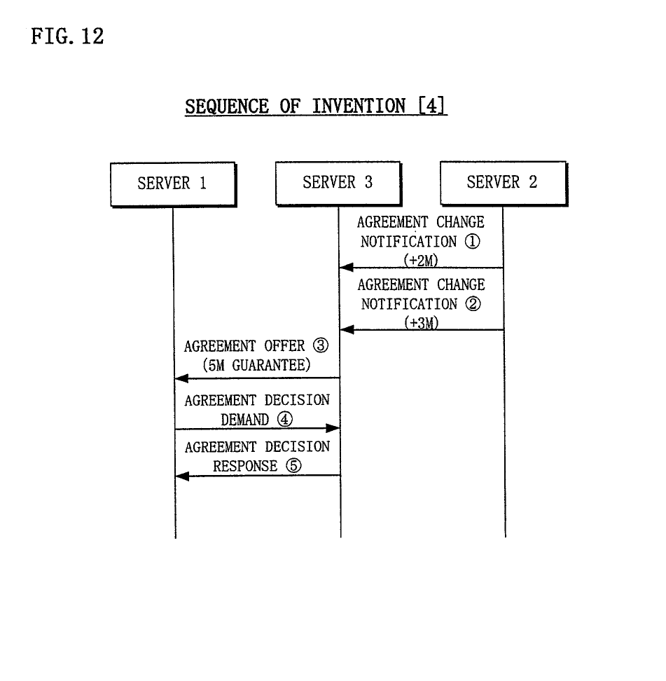

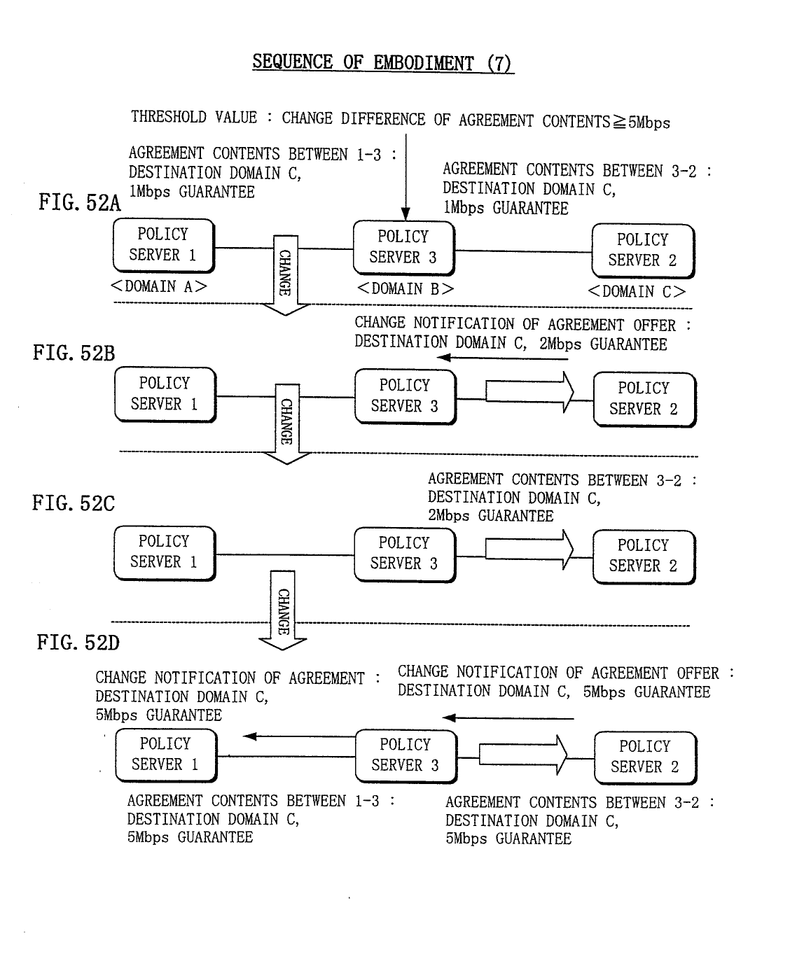

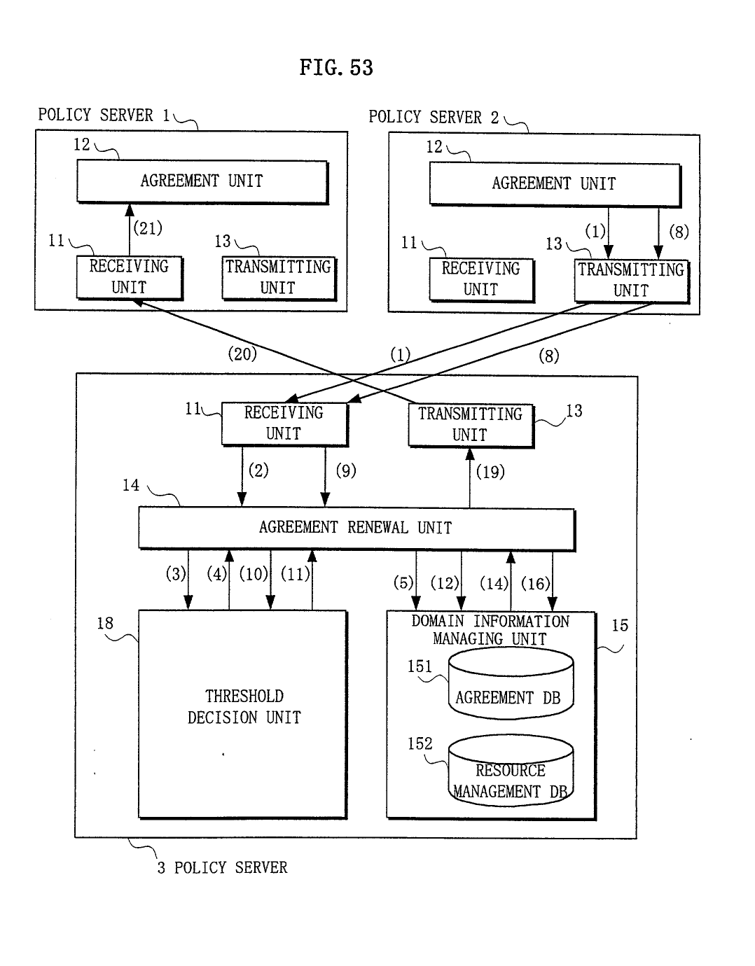

FIG. 52 shows an embodiment (7) of the present invention, which particularly shows a schematic sequence of the present invention [4] shown in FIGS. 11 and 12.

Namely, the server 3 as shown in FIG. 52A makes an agreement offer under the condition that the deference between changes is over a threshold value (bandwidth of 5 Mbps). Accordingly, in the case where the agreement as a bandwidth guarantee of 1 Mbps as shown in FIG. 52A, the agreement offer for the server 1 is not made only if the agreement change notification of 2 Mbps is received from the server 2 as shown in FIG. 52B, so that the bandwidth guarantee of 2 Mbps is maintained unchanged as shown in FIG. 52A.

Then, as shown in FIG. 52D, in the presence of a change notification of 5 Mbps by the server 2, the server 3 makes a change notification (agreement offer) to the server 1 for mutual bandwidth guarantee of 5 Mbps.

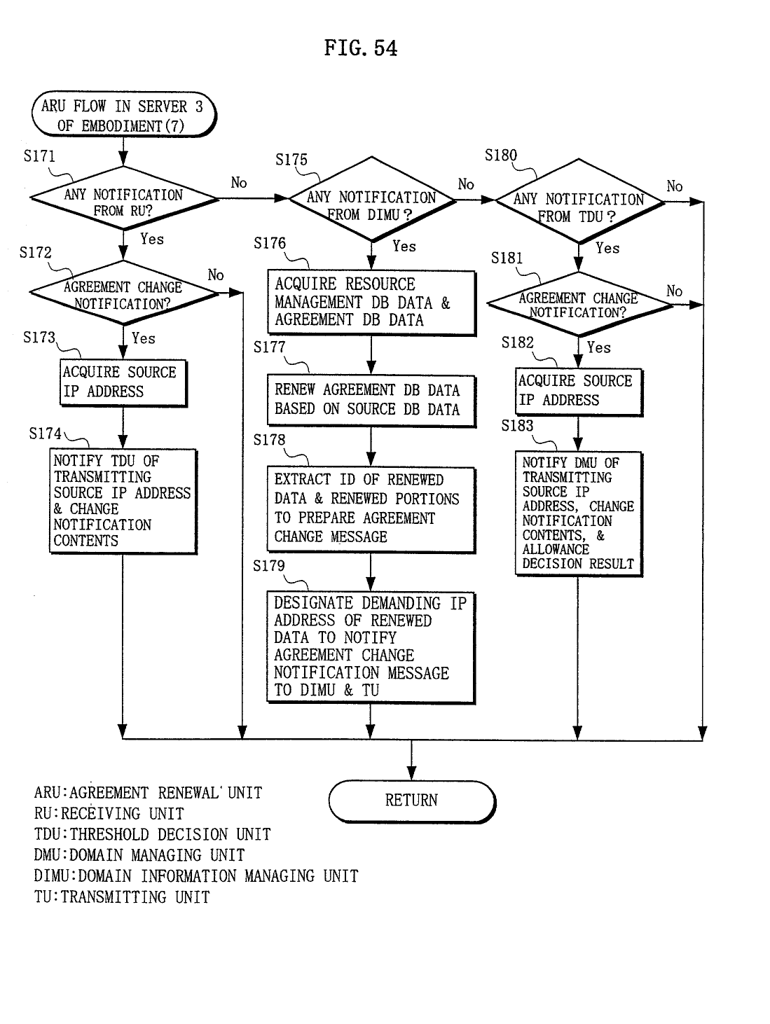

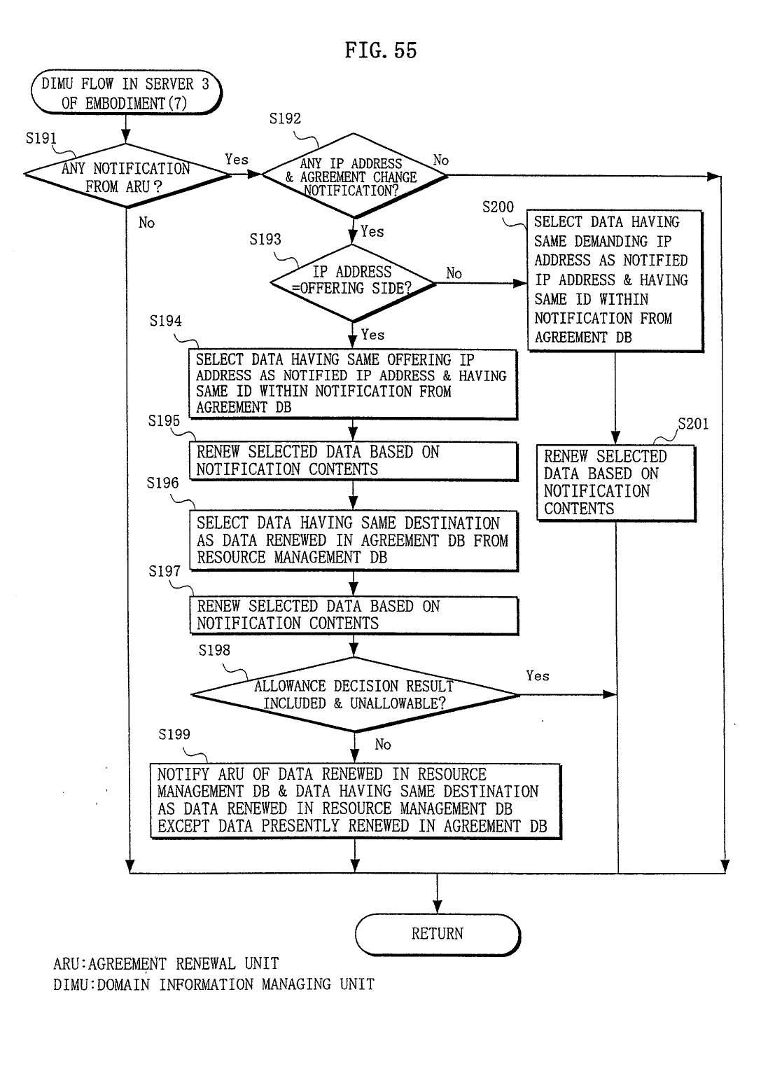

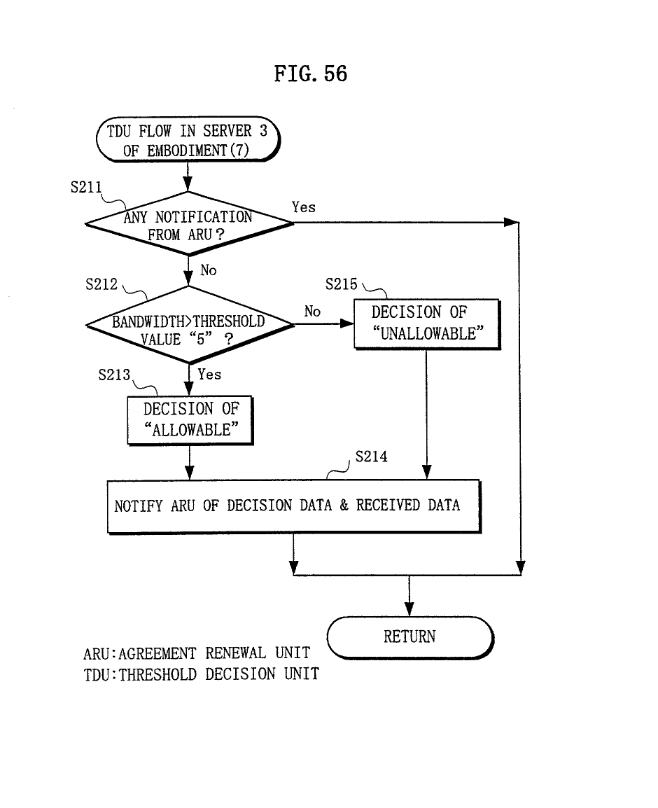

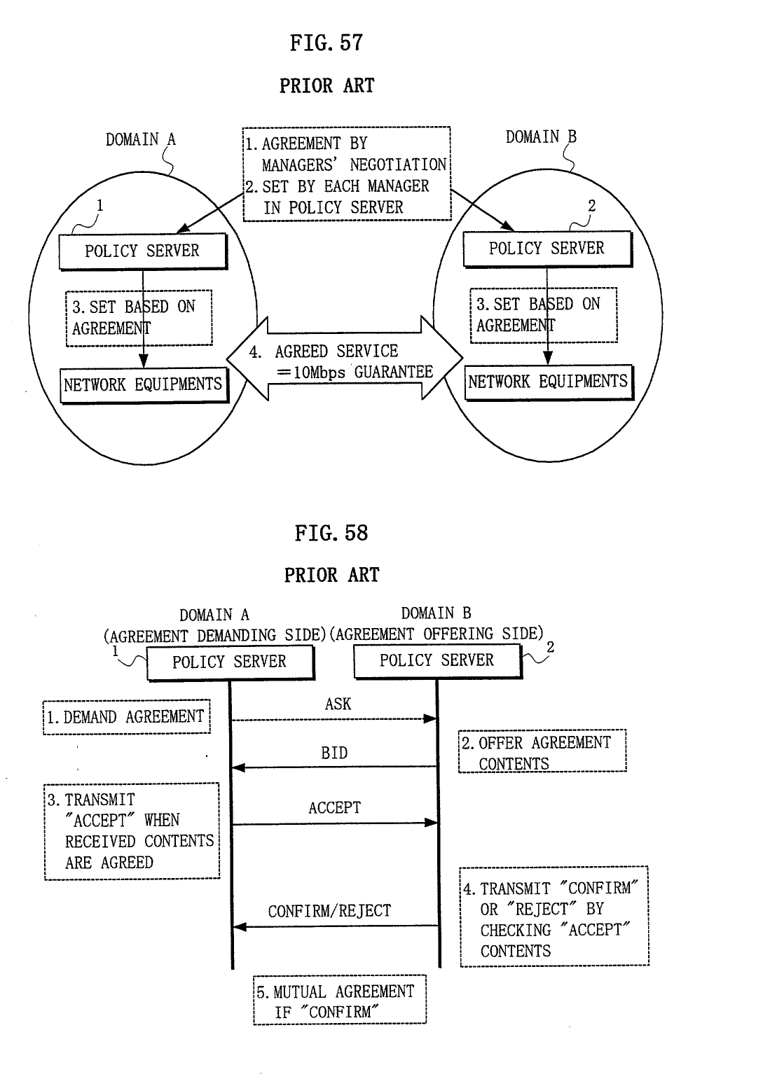

FIG. 53 shows an arrangement of this embodiment (7), which is basically the same as the schematic arrangement shown in FIG. 11 while specific operations of FIGS. 12 and 52 are shown. Hereinafter, these operations will be described also referring to FIGS. 54-56. It is to be noted that the above noted tables 1-4 are similarly applied to this embodiment.

At first, it is supposed that the server 3 holds data for the resource management DB 152 of its own domain B as shown in the following table:

TABLE 68
SOURCE MANAGEMENT DB OF SERVER 3

| | | DESTINATION |
|---|---|---|
| BANDWIDTH (Mbps) | ACCOUNT (YEN) | ADDRESS |
| 1 | 1000 | 10.10.20.0 |
| 1 | 1000 | 10.10.30.0 |

(1) The server 2 transmits an agreement change notification \mathring{1} to the server 3 as shown in the following table:

TABLE 69
AGREEMENT CHANGE NOTIFICATION

| | | BANDWIDTH | ACCOUNT | DESTINATION |
|---|---|---|---|---|
| FLAG | ID | (Mbps) | (YEN) | ADDRESS |
| 5 | 1 | 2 | | |

(2) The server 3 receives the agreement change notification \mathring{1} at the receiving unit 11 to be notified to the agreement renewal unit 14 (steps S171, S172).

(3) The agreement renewal unit 14 transmits the received data to the threshold decision unit 18 (steps S173, S174).

(4) The threshold decision unit 18 compares the value of change notification bandwidth with that of bandwidth guarantee of “5 Mbps” that is a threshold value of this embodiment (steps S211, S212), decides to be unallowable because it is below the threshold value, and notifies the agreement renewal unit 14 of the result together with the received data (steps S215, S214).

(5) The agreement renewal unit 14 notifies the domain information managing unit 15 of the data of unallowance and the received data (steps S180-S183).

(6) The domain information managing unit 15 renews the agreement DB 151 and the resource management DB 152 based on their ID's as shown in the following table (steps S194-S197):

TABLE 70
AGREEMENT DB

| | OFFERING | DEMANDING | BANDWIDTH | ACCOUNT | DESTINATION |
|---|---|---|---|---|---|
| ID | IP | IP | (Mbps) | (YEN) | ADDRESS |
| 1 | 10.10.30.1 | 10.10.20.1 | 2 | 1000 | 10.10.30.0 |
| 2 | 10.10.20.1 | 10.10.10.1 | 1 | 2000 | 10.10.30.0 |

TABLE 71
SOURCE MANAGEMENT DB

| | | DESTINATION |
|---|---|---|
| BANDWIDTH (Mbps) | ACCOUNT (YEN) | ADDRESS |
| 1 | 1000 | 10.10.20.0 |
| 2 | 1000 | 10.10.30.0 |

(7) The domain information managing unit 15 gives notification to the agreement renewal unit 14 because the received data have been found unallowable (step S198).

(8) The agreement change notification \mathring{2} shown in the following table is again transmitted from the server 2 to the server 3:

TABLE 72
AGREEMENT CHANGE NOTIFICATION

| | | BANDWIDTH | ACCOUNT | DESTINATION |
|---|---|---|---|---|
| FLAG | ID | (Mbps) | (YEN) | ADDRESS |
| 5 | 1 | 5 | | |

(9) The server 3 receives the agreement change notification \mathring{2} at the receiving unit 11 to be notified to the agreement renewal unit 14.

(10) The agreement renewal unit 14 transmits the received data to the threshold decision unit 18.

(11) The threshold decision unit 18 again compares the bandwidth value with the threshold value of “5 Mbps” (steps S211, S212). Since the threshold value is now exceeded, the threshold decision unit 18 decides it to be allowable, which is notified to the agreement renewal unit 14 together with the received data (steps S213, S214).

(12) The agreement renewal unit 14 notifies the domain information managing unit 15 of the data of allowance and the received data (steps S180-S183).

(13) The domain information managing unit 15 renews the agreement DB 151 and the resource management DB 152 based on their ID's as shown in the following table (steps S191-S197):

TABLE 73
AGREEMENT DB

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 1 | 10.10.30.1 | 10.10.20.1 | 5 | 1000 | 10.10.30.0 |
| 2 | 10.10.20.1 | 10.10.10.1 | 1 | 2000 | 10.10.30.0 |

TABLE 74
SOURCE MANAGEMENT DB

| | ACCOUNT | DESTINATION |
|---|---|---|
| BANDWIDTH (Mbps) | (YEN) | ADDRESS |
| 1 | 1000 | 10.10.20.0 |
| 5 | 1000 | 10.10.30.0 |

(14) The domain information managing unit 15 notifies the agreement renewal unit 14 of the data shown in the following tables, having the same destination net address except the renewed data, associated with the agreement change after the renewal (step S199).

TABLE 75
AGREEMENT DATA

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 2 | 10.10.20.1 | 10.10.10.1 | 1 | 2000 | 10.10.30.0 |

TABLE 76
SOURCE MANAGEMENT DATA

| | ACCOUNT | DESTINATION |
|---|---|---|
| BANDWIDTH (Mbps) | (YEN) | ADDRESS |
| 5 | 1000 | 10.10.30.0 |

(15) The agreement renewal unit 14 compares the bandwidths of the agreement data before and after the change as shown in the following tables to determine an agreement to be changed (steps S175-S177). In this embodiment, it is found necessary to change the bandwidth regarding the agreement of ID 2 to 5 Mbps as shown in the following tables:

TABLE 77
BEFORE CHANGE

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 2 | 10.10.20.1 | 10.10.10.1 | 1 | 2000 | 10.10.30.0 |

TABLE 78
AFTER CHANGE

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 2 | 10.10.20.1 | 10.10.10.1 | 5 | 2000 | 10.10.30.0 |

(16) The agreement renewal unit 14 provides a data renewal notification shown in the following table to the domain information managing unit 15 with the agreement demanding IP address being made “10.10.10.1” (steps S178, S179):

TABLE 79
NOTIFICATION CONTENTS

| | | | |
|---|---|---|---|
| | BANDWIDTH | ACCOUNT | DESTINATION |
| ID | (Mbps) | (YEN) | ADDRESS |

| | |
|---|---|
| 2 | 5 |

(17) The domain information managing unit 15 renews the agreement DB 151 based on the notified data as shown in the following table (steps S192-S197):

TABLE 80
AGREEMENT DB

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 1 | 10.10.30.1 | 10.10.20.1 | 5 | 1000 | 10.10.30.0 |
| 2 | 10.10.20.1 | 10.10.10.1 | 5 | 2000 | 10.10.30.0 |

(18) The agreement renewal unit 14 prepares a message of an agreement change notification (agreement offer) \mathring{3} shown in the following table with the destination IP address being made “10.10.10.1” based on the agreement change portions (step S178):

TABLE 81

| | | | |
|---|---|---|---|
| | BANDWIDTH | ACCOUNT | DESTINATION |
| ID | (Mbps) | (YEN) | ADDRESS |

| | |
|---|---|
| 2 | 5 |

(19) The agreement renewal unit 14 transmits the prepared message to the transmitting unit 13 (step S179).

(20) The transmitting unit 13 transmits the message of the agreement offer \mathring{3} to the server 1 of the designated destination IP address (10.10.10.1).

(21) The server 1 having received the message of the agreement offer \mathring{3} confirms the change of agreement contents to renew the agreement made with the server 3 as shown in the following table:

TABLE 82
AGREEMENT CONTENTS OF SERVER 1

| | | DEMAND- | BAND- | | DESTI- |
|---|---|---|---|---|---|
| | OFFERING | ING | WIDTH | ACCOUNT | NATION |
| ID | IP | IP | (Mbps) | (YEN) | ADDRESS |
| 2 | 10.10.20.1 | 10.10.10.1 | 5 | 2000 | 10.10.30.0 |

(22) Then, the agreement decision demand \mathring{4} and the agreement decision response \mathring{5} are transferred between the servers 1 and 3 in the same manner as shown in FIG. 10.

Thus, the server 3 makes it possible to control the interval upon automatically changing other agreement contents based on the change regarding the agreement by using a certain threshold value.

As aforementioned, it is arranged in a server according to the present invention such that when an agreement such as a service guarantee between domains is dynamically changed, that is an agreement with a server is changed or a change of network state occurs in other servers, or upon making an agreement with a server, an agreement with other associated servers is changed, and alternatively the change is performed only in excess of a fixed threshold value, whereby an optimum agreement state can be always realized between servers.

What we claim is:

1. A server which manages an agreement for a service offered between domains through a network, comprising:
a receiving unit for receiving a change notification of an agreement from an agreement offering side,
a domain information managing unit,
an agreement renewal unit for selecting and renewing the agreement with the agreement offering side from the domain information managing unit by the change notification, and selecting an agreement with an agreement demanding side associated with the change notification to prepare a corresponding change notification of the latter agreement, and
a transmitting unit for transmitting the corresponding change notification from the agreement renewal unit to the agreement demanding side.

2. A server which manages an agreement for a service offered between domains through a network, comprising:
a receiving unit for receiving a change demand of an agreement from an agreement demanding side,
a domain information managing unit,
an agreement renewal unit for selecting and renewing the agreement with the agreement demanding side from the domain information managing unit by the change demand, and selecting an agreement with an agreement offering side associated with the change demand to prepare a corresponding change demand of the latter agreement, and
a transmitting unit for transmitting the corresponding change demand from the agreement renewal unit to the agreement demanding side.

3. A server as claimed in claim 2 wherein the agreement renewal unit prepares a change notification of the agreement corresponding to the change demand to be transmitted to the agreement demanding side from the transmitting unit.

4. A server which manages an agreement for a service offered between domains through a network, comprising:
a network information collecting unit,
a domain information managing unit,
an agreement renewal unit for making the network information collecting unit collect information regarding a network variation, for selecting an agreement from the domain information managing unit when the information indicates the agreement with an agreement demanding side to be changed, for renewing the selected agreement to correspond to the network variation, and for preparing a change demand for an agreement with an associated agreement offering side, and
a transmitting unit for transmitting the change demand from the agreement renewal unit to the agreement offering side.

5. A server which manages an agreement for a service offered between domains through a network, comprising:
a network information collecting unit,
a domain information managing unit,
an agreement renewal unit for making the network information collection unit collect information regarding a network variation, for selecting an agreement from the domain information managing unit when the information indicates the agreement with an agreement offering side to be changed, for renewing the selected agreement to correspond to the network variation, and for preparing a change notification for an agreement with an associated agreement demanding side, and
a transmitting unit for transmitting the change notification from the agreement renewal unit to the agreement demanding side.

6. A server which manages an agreement for a service offered between domains through a network, comprising:
a receiving unit for receiving an agreement offer from an agreement offering side,
a domain information managing unit,
an inter-domain cooperating unit,
an agreement renewal unit for notifying the inter-domain cooperating unit of the agreement offer, and
a transmitting unit;
the inter-domain cooperating unit acquiring an agreement associated with the agreement offer from the domain information managing unit, preparing a new agreement offer for an agreement demanding side, based on the agreement, to be notified to the agreement renewal unit,
the agreement renewal unit selecting and renewing an agreement associated with the new agreement offer from the domain information managing unit, and transmitting the new agreement offer to the agreement demanding side from the transmitting unit.

7. A server as claimed in claim 6 wherein when receiving an agreement decision demand followed by the agreement offer through the receiving unit from the agreement demanding side, the agreement renewal unit notifies the inter-domain cooperating unit of the agreement decision demand, the inter-domain cooperating unit acquires an agreement associated with the agreement decision demand from the domain information managing unit and prepares a new agreement decision demand for the agreement offering side, based on the agreement, to be notified to the agreement renewal unit, and the agreement renewal unit selects and renews an agreement associated with the new agreement decision demand from the domain information managing unit and transmits the new agreement decision demand to the agreement offering side from the transmitting unit.

8. A server as claimed in claim 7 wherein when receiving an agreement decision response followed by the agreement decision demand though the receiving unit from the agreement offering side, the agreement renewal unit notifies the inter-domain cooperating unit of the agreement decision response, the inter-domain cooperating unit acquires an agreement associated with the agreement decision response from the domain information managing unit and prepares a new agreement decision response for the agreement demanding side, based on the agreement, to be notified to the agreement renewal unit, which acquires and renews an agreement associated with the new agreement decision response from the domain information managing unit, selects and renews information associated with the agreement decision response, and transmits the new agreement decision response to the agreement demanding side from the transmitting unit.

9. A server as claimed in claim 8 wherein when receiving an agreement demand from the agreement demanding side though the receiving unit, the agreement renewal unit notifies the inter-domain cooperating unit of the agreement demand, the inter-domain cooperating unit acquires an agreement associated with the agreement demand from the domain information managing unit and prepares a new agreement demand for the agreement offering side, based on the agreement, to be notified to the agreement renewal unit, which acquires and renews an agreement associated with the new agreement demand from the domain information managing unit and transmits the new agreement demand to the agreement offering side from the transmitting unit, whereby the agreement offer is transmitted from the agreement offering side.

10. A server which manages an agreement for a service offered between domains through a network, comprising:
a receiving unit for receiving an agreement change notification from outside,
a domain information managing unit,
a threshold decision unit having a threshold value,
an agreement renewal unit for notifying the threshold decision unit of the agreement change notification, and
a transmitting unit,
the threshold decision unit acquiring information regarding the agreement change notification from the domain information managing unit, and deciding whether or not an agreement renewal regarding the agreement change notification should be made, based on the threshold value, to be notified to the agreement renewal unit, whereby the agreement renewal unit, upon agreement renewal, renews an agreement associated with the domain information managing unit and transmits an agreement offer to an agreement demanding side from the transmitting unit.
